(19) United States
(12) Patent Application Publication
(10) Pub. No.: US 2015/0016502 A1
(43) Pub. Date: Jan. 15, 2015

(54) DEVICE AND METHOD FOR SCALABLE CODING OF VIDEO INFORMATION

(71) Applicant: QUALCOMM Incorporated, San Diego, CA (US)

(72) Inventors: Krishnakanth RAPAKA, San Diego, CA (US); Vadim SEREGIN, San Diego, CA (US); Jianle CHEN, San Diego, CA (US); Ye-Kui WANG, San Diego, CA (US); Marta KARCZEWICZ, San Diego, CA (US)

(21) Appl. No.: 14/329,804

(22) Filed: Jul. 11, 2014

Related U.S. Application Data
(60) Provisional application No. 61/846,509, filed on Jul. 15, 2013.
(60) Provisional application No. 61/847,931, filed on Jul. 18, 2013.
(60) Provisional application No. 61/884,978, filed on Sep. 30, 2013.

(51) Int. Cl. H04N 19/187; H04N 19/50

(52) U.S. Cl. CPC H04N 19/00321; H04N 19/00569
USPC 375/240.02

(57) ABSTRACT

An apparatus configured to code video information includes a memory unit and a processor in communication with the memory unit. The memory unit is configured to store video information associated with a current layer and an enhancement layer, the current layer having a current picture. The processor is configured to determine whether the current layer may be coded using information from the enhancement layer, determine whether the enhancement layer has an enhancement layer picture corresponding to the current picture, and in response to determining that the current layer may be coded using information from the enhancement layer and that the enhancement layer has an enhancement layer picture corresponding to the current picture, code the current picture based on the enhancement layer picture. The processor may encode or decode the video information.

### CROSS-REFERENCE TO RELATED APPLICATIONS

This application claims priority to U.S. Provisional No. 61/846,509, filed Jul. 15, 2013, U.S. Provisional No. 61/847,931, filed Jul. 18, 2013, and U.S. Provisional No. 61/884,978, filed Sep. 30, 2013.

### TECHNICAL FIELD

This disclosure relates to the field of video coding and compression, particularly to scalable video coding (SVC), multiview video coding (MVC), or 3D video coding (3DV).

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video coding techniques.

Video compression techniques perform spatial (intra-picture) prediction and/or temporal (inter-picture) prediction to reduce or remove redundancy inherent in video sequences. For block-based video coding, a video slice (e.g., a video frame, a portion of a video frame, etc.) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy encoding may be applied to achieve even more compression.

### SUMMARY

Scalable video coding (SVC) refers to video coding in which a base layer (BL), sometimes referred to as a reference layer (RL), and one or more scalable enhancement layers (ELs) are used. In SVC, the base layer can carry video data with a base level of quality. The one or more enhancement layers can carry additional video data to support, for example, higher spatial, temporal, and/or signal-to-noise (SNR) levels. Enhancement layers may be defined relative to a previously encoded layer. For example, a bottom layer may serve as a BL, while a top layer may serve as an EL. Middle layers may serve as either ELs or RLs, or both. For example, a layer in the middle may be an EL for the layers below it, such as the base layer or any intervening enhancement layers, and at the same time serve as a RL for one or more enhancement layers above it. Similarly, in the Multiview or 3D extension of the HEVC standard, there may be multiple views, and information of one view may be utilized to code (e.g., encode or decode) the information of another view (e.g., motion estimation, motion vector prediction and/or other redundancies).

In SVC, the transmitted bitstream includes multiple layers and the decoder may choose to decode one or more of the multiple layers depending on bitrate constraints of the display device. For example, a bitstream may include two layers, a BL and an EL. Decoding the BL may require 3 mbps and decoding both the BL and the EL may require 6 mbps. For a device that has a capacity of 4.5 mbps, the decoder may choose to decode just the BL at 3 mbps, or a combination of the BL and the EL, while abandoning just enough EL packets to stay under 4.5 mbps to take advantage of the picture quality improvement resulting from the additional El packets that are decoded.

However, in some implementations, EL pictures may be used to code BL pictures to achieve greater coding efficiency, because EL generally has higher quality pictures. In such implementations, EL pictures may be necessary to accurately decode BL pictures. This constraint poses a problem when, as discussed above, the decoder may choose to decode just the BL (or a combination of the BL and the EL while abandoning some of the EL packets) due to bitrate concerns. When any portion of the EL that is used to code the BL is missing, the decoder may instead use a portion of the BL that corresponds to the missing portion. In such a case, a phenomenon known as a drift is introduced. A drift occurs when the texture information (e.g., samples) or the motion information (e.g., motion vectors) of the BL pictures, which is optimized using EL pictures, is applied to the BL pictures. The drift may degrade the video quality.

A coding scheme that exploits the coding efficiency gain resulting from allowing a lower layer (e.g., BL) to be coded based on a higher layer (e.g., EL) while minimizing the drift is desired.

The systems, methods and devices of this disclosure each have several innovative aspects, no single one of which is solely responsible for the desirable attributes disclosed herein.

In one aspect, an apparatus configured to code (e.g., encode or decode) video information includes a memory unit and a processor in communication with the memory unit. The memory unit is configured to store video information associated with a current layer and an enhancement layer, the current layer having a current picture. The processor is configured to determine whether the current layer may be coded using information from the enhancement layer, determine whether the enhancement layer has an enhancement layer picture corresponding to the current picture, and in response to determining that the current layer may be coded using information from the enhancement layer and that the enhancement layer has an enhancement layer picture corresponding to the current picture, code the current picture based on the enhancement layer picture. The processor may encode or decode the video information.

In one aspect, a method of coding (e.g., encoding or decoding) video information comprises determining whether a current layer may be coded using information from an enhancement layer; determining whether the enhancement layer has an enhancement layer picture corresponding to a current picture in the current layer; and in response to determining that the current layer may be coded using information from the enhancement layer and that the enhancement layer has an enhancement layer picture corresponding to the current picture, coding the current picture based on the enhancement layer picture.

In one aspect, a non-transitory computer readable medium comprises code that, when executed, causes an apparatus to perform a process. The process includes storing video information associated with a current layer and an enhancement layer, the current layer having a current picture; determining whether the current layer may be coded using information from the enhancement layer; determining whether the enhancement layer has an enhancement layer picture corresponding to the current picture; and in response to determining that the current layer may be coded using information from the enhancement layer and that the enhancement layer has an enhancement layer picture corresponding to the current picture, coding the current picture based on the enhancement layer picture.

In one aspect, a video coding device configured to code video information comprises means for storing video information associated with a current layer and an enhancement layer, the current layer having a current picture; means for determining whether the current layer may be coded using information from the enhancement layer; means for determining whether the enhancement layer has an enhancement layer picture corresponding to the current picture; and means for coding the current picture based on the enhancement layer picture in response to determining that the current layer may be coded using information from the enhancement layer and that the enhancement layer has an enhancement layer picture corresponding to the current picture.

### BRIEF DESCRIPTION OF DRAWINGS

FIG. 1A is a block diagram illustrating an example video encoding and decoding system that may utilize techniques in accordance with aspects described in this disclosure.

FIG. 1B is a block diagram illustrating another example video encoding and decoding system that may perform techniques in accordance with aspects described in this disclosure.

FIG. 2A is a block diagram illustrating an example of a video encoder that may implement techniques in accordance with aspects described in this disclosure.

FIG. 2B is a block diagram illustrating an example of a video encoder that may implement techniques in accordance with aspects described in this disclosure.

FIG. 3A is a block diagram illustrating an example of a video decoder that may implement techniques in accordance with aspects described in this disclosure.

FIG. 3B is a block diagram illustrating an example of a video decoder that may implement techniques in accordance with aspects described in this disclosure.

FIG. 4 illustrates a flow chart illustrating a method of coding video information, according to one embodiment of the present disclosure.

### DETAILED DESCRIPTION

Certain embodiments described herein relate to inter-layer prediction for scalable video coding in the context of advanced video codecs, such as HEVC (High Efficiency Video Coding). More specifically, the present disclosure relates to systems and methods for improved performance of inter-layer prediction in scalable video coding (SVC) extension of HEVC.

In the description below, H.264/AVC techniques related to certain embodiments are described; the HEVC standard and related techniques are also discussed. While certain embodiments are described herein in the context of the HEVC and/or H.264 standards, one having ordinary skill in the art may appreciate that systems and methods disclosed herein may be applicable to any suitable video coding standard. For example, embodiments disclosed herein may be applicable to one or more of the following standards: ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions.

HEVC generally follows the framework of previous video coding standards in many respects. The unit of prediction in HEVC is different from that in certain previous video coding standards (e.g., macroblock). In fact, the concept of macroblock does not exist in HEVC as understood in certain previous video coding standards. Macroblock is replaced by a hierarchical structure based on a quadtree scheme, which may provide high flexibility, among other possible benefits. For example, within the HEVC scheme, three types of blocks, Coding Unit (CU), Prediction Unit (PU), and Transform Unit (TU), are defined. CU may refer to the basic unit of region splitting. CU may be considered analogous to the concept of macroblock, but it does not restrict the maximum size and may allow recursive splitting into four equal size CUs to improve the content adaptivity. PU may be considered the basic unit of inter/intra prediction and it may contain multiple arbitrary shape partitions in a single PU to effectively code irregular image patterns. TU may be considered the basic unit of transform. It can be defined independently from the PU; however, its size may be limited to the CU to which the TU belongs. This separation of the block structure into three different concepts may allow each to be optimized according to its role, which may result in improved coding efficiency.

For purposes of illustration only, certain embodiments disclosed herein are described with examples including only two layers (e.g., a lower layer such as the base layer, and a higher layer such as the enhancement layer). It should be understood that such examples may be applicable to configurations including multiple base and/or enhancement layers. In addition, for ease of explanation, the following disclosure includes the terms “frames” or “blocks” with reference to certain embodiments. However, these terms are not meant to be limiting. For example, the techniques described below can be used with any suitable video units, such as blocks (e.g., CU, PU, TU, macroblocks, etc.), slices, frames, etc.

### Video Coding Standards

A digital image, such as a video image, a TV image, a still image or an image generated by a video recorder or a computer, may consist of pixels or samples arranged in horizontal and vertical lines. The number of pixels in a single image is typically in the tens of thousands. Each pixel typically contains luminance and chrominance information. Without compression, the quantity of information to be conveyed from an image encoder to an image decoder is so enormous that it renders real-time image transmission impossible. To reduce the amount of information to be transmitted, a number of different compression methods, such as JPEG, MPEG and H.263 standards, have been developed.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions.

In addition, a new video coding standard, namely High Efficiency Video Coding (HEVC), is being developed by the Joint Collaboration Team on Video Coding (JCT-VC) of ITU-T Video Coding Experts Group (VCEG) and ISO/IEC Motion Picture Experts Group (MPEG). The full citation for the HEVC Draft 10 is document JCTVC-L1003, Bross et al., “High Efficiency Video Coding (HEVC) Text Specification Draft 10,” Joint Collaborative Team on Video Coding (JCT-VC) of ITU-T SG16 WP3 and ISO/IEC JTC1/SC29/WG11, 12th Meeting: Geneva, Switzerland, Jan. 14, 2013 to Jan. 23, 2013. The multiview extension to HEVC, namely MV-HEVC, and the scalable extension to HEVC, named SHVC, are also being developed by the JCT-3V (ITU-T/ISO/IEC Joint Collaborative Team on 3D Video Coding Extension Development) and JCT-VC, respectively.

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the present disclosure. For example, an apparatus may be implemented or a method may be practiced using any number of the aspects set forth herein. In addition, the scope of the present disclosure is intended to cover such an apparatus or method which is practiced using other structure, functionality, or structure and functionality in addition to or other than the various aspects of the present disclosure set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The attached drawings illustrate examples. Elements indicated by reference numbers in the attached drawings correspond to elements indicated by like reference numbers in the following description. In this disclosure, elements having names that start with ordinal words (e.g., “first,” “second,” “third,” and so on) do not necessarily imply that the elements have a particular order. Rather, such ordinal words are merely used to refer to different elements of a same or similar type.

### Video Coding System

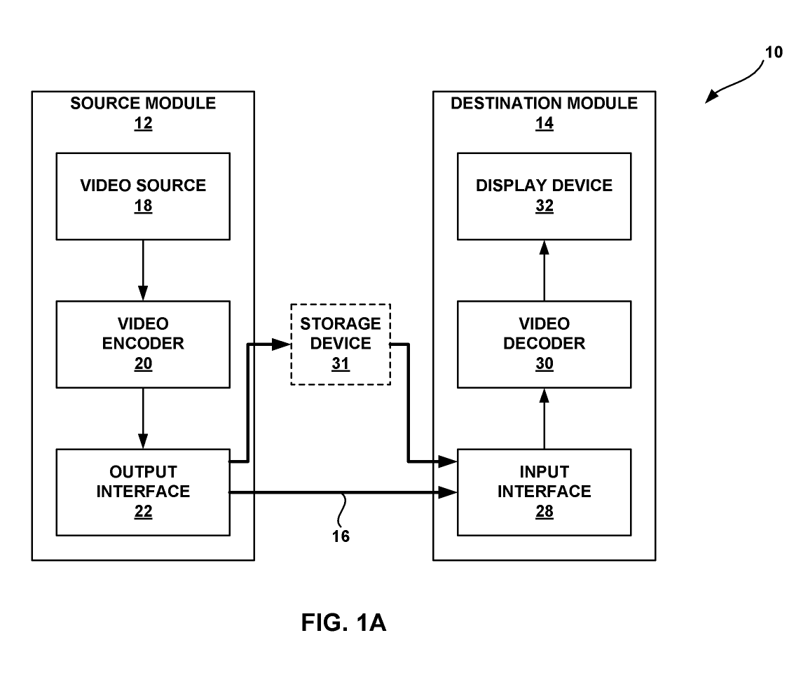

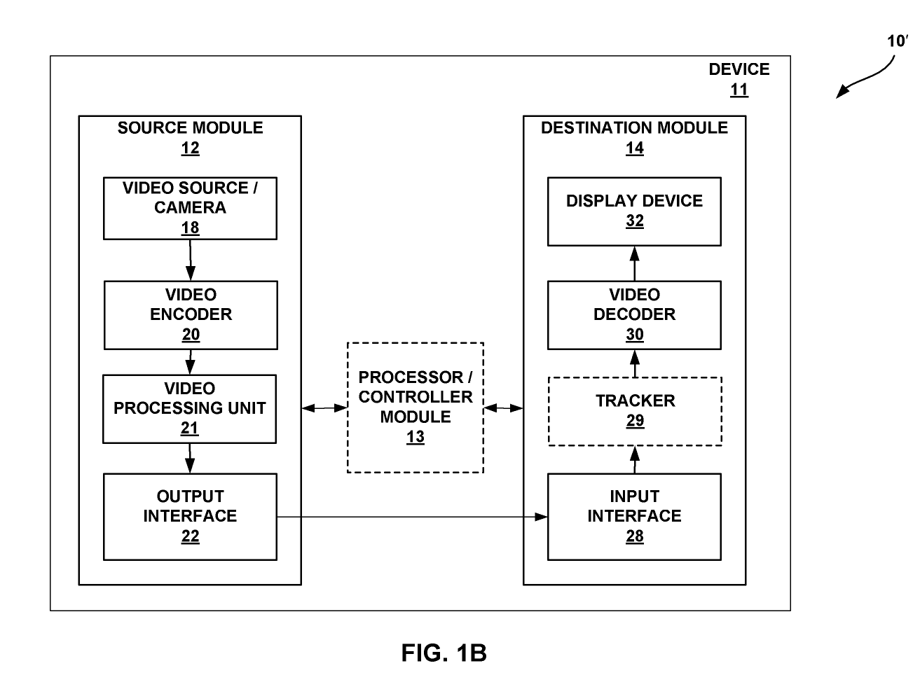

FIG. 1A is a block diagram that illustrates an example video coding system 10 that may utilize techniques in accordance with aspects described in this disclosure. As used described herein, the term “video coder” refers generically to both video encoders and video decoders. In this disclosure, the terms “video coding” or “coding” may refer generically to video encoding and video decoding.

As shown in FIG. 1A, video coding system 10 includes a source module 12 that generates encoded video data to be decoded at a later time by a destination module 14. In the example of FIG. 1A, the source module 12 and destination module 14 are on separate devices—specifically, the source module 12 is part of a source device, and the destination module 14 is part of a destination device. It is noted, however, that the source and destination modules 12, 14 may be on or part of the same device, as shown in the example of FIG. 1B.

With reference once again, to FIG. 1A, the source module 12 and the destination module 14 may comprise any of a wide range of devices, including desktop computers, notebook (e.g., laptop) computers, tablet computers, set-top boxes, telephone handsets such as so-called “smart” phones, so-called “smart” pads, televisions, cameras, display devices, digital media players, video gaming consoles, video streaming device, or the like. In some cases, the source module 12 and the destination module 14 may be equipped for wireless communication.

The destination module 14 may receive the encoded video data to be decoded via a link 16. The link 16 may comprise any type of medium or device capable of moving the encoded video data from the source module 12 to the destination module 14. In the example of FIG. 1A, the link 16 may comprise a communication medium to enable the source module 12 to transmit encoded video data directly to the destination module 14 in real-time. The encoded video data may be modulated according to a communication standard, such as a wireless communication protocol, and transmitted to the destination module 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source module 12 to the destination module 14.

Alternatively, encoded data may be output from an output interface 22 to an optional storage device 31. Similarly, encoded data may be accessed from the storage device 31 by an input interface 28. The storage device 31 may include any of a variety of distributed or locally accessed data storage media such as a hard drive, flash memory, volatile or non-volatile memory, or any other suitable digital storage media for storing encoded video data. In a further example, the storage device 31 may correspond to a file server or another intermediate storage device that may hold the encoded video generated by the source module 12. The destination module 14 may access stored video data from the storage device 31 via streaming or download. The file server may be any type of server capable of storing encoded video data and transmitting that encoded video data to the destination module 14. Example file servers include a web server (e.g., for a website), an FTP server, network attached storage (NAS) devices, or a local disk drive. The destination module 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device 31 may be a streaming transmission, a download transmission, or a combination of both.

The techniques of this disclosure are not limited to wireless applications or settings. The techniques may be applied to video coding in support of any of a variety of multimedia applications, such as over-the-air television broadcasts, cable television transmissions, satellite television transmissions, streaming video transmissions, e.g., via the Internet (e.g., dynamic adaptive streaming over HTTP (DASH), etc.), encoding of digital video for storage on a data storage medium, decoding of digital video stored on a data storage medium, or other applications. In some examples, video coding system 10 may be configured to support one-way or two-way video transmission to support applications such as video streaming, video playback, video broadcasting, and/or video telephony.

In the example of FIG. 1A, the source module 12 includes a video source 18, video encoder 20 and an output interface 22. In some cases, the output interface 22 may include a modulator/demodulator (modem) and/or a transmitter. In the source module 12, the video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if the video source 18 is a video camera, the source module 12 and the destination module 14 may form so-called camera phones or video phones, as illustrated in the example of FIG. 1B. However, the techniques described in this disclosure may be applicable to video coding in general, and may be applied to wireless and/or wired applications.

The captured, pre-captured, or computer-generated video may be encoded by the video encoder 20. The encoded video data may be transmitted directly to the destination module 14 via the output interface 22 of the source module 12. The encoded video data may also (or alternatively) be stored onto the storage device 31 for later access by the destination module 14 or other devices, for decoding and/or playback.

In the example of FIG. 1A, the destination module 14 includes an input interface 28, a video decoder 30, and a display device 32. In some cases, the input interface 28 may include a receiver and/or a modem. The input interface 28 of the destination module 14 may receive the encoded video data over the link 16. The encoded video data communicated over the link 16, or provided on the storage device 31, may include a variety of syntax elements generated by the video encoder 20 for use by a video decoder, such as the video decoder 30, in decoding the video data. Such syntax elements may be included with the encoded video data transmitted on a communication medium, stored on a storage medium, or stored a file server.

The display device 32 may be integrated with, or external to, the destination module 14. In some examples, the destination module 14 may include an integrated display device and also be configured to interface with an external display device. In other examples, the destination module 14 may be a display device. In general, the display device 32 displays the decoded video data to a user, and may comprise any of a variety of display devices such as a liquid crystal display (LCD), a plasma display, an organic light emitting diode (OLED) display, or another type of display device.

In related aspects, FIG. 1B shows an example video encoding and decoding system 10′ wherein the source and destination modules 12, 14 are on or part of a device or user device 11. The device 11 may be a telephone handset, such as a “smart” phone or the like. The device 11 may include an optional controller/processor module 13 in operative communication with the source and destination modules 12, 14. The system 10′ of FIG. 1B may further include a video processing unit 21 between the video encoder 20 and the output interface 22. In some implementations, the video processing unit 21 is a separate unit, as illustrated in FIG. 1B; however, in other implementations, the video processing unit 21 can be implemented as a portion of the video encoder 20 and/or the processor/controller module 13. The system 10′ may also include an optional tracker 29, which can track an object of interest in a video sequence. The object or interest to be tracked may be segmented by a technique described in connection with one or more aspects of the present disclosure. In related aspects, the tracking may be performed by the display device 32, alone or in conjunction with the tracker 29. The system 10′ of FIG. 1B, and components thereof, are otherwise similar to the system 10 of FIG. 1A, and components thereof.

Video encoder 20 and video decoder 30 may operate according to a video compression standard, such as the High Efficiency Video Coding (HEVC) standard presently under development, and may conform to a HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include MPEG-2 and ITU-T H.263.

Although not shown in the examples of FIGS. 1A and 1B, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

The video encoder 20 and the video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of the video encoder 20 and the video decoder 30 may be included in one or more encoders or decoders, either of which may be integrated as part of a combined encoder/decoder (CODEC) in a respective device.

### Video Coding Process

As mentioned briefly above, video encoder 20 encodes video data. The video data may comprise one or more pictures. Each of the pictures is a still image forming part of a video. In some instances, a picture may be referred to as a video “frame.” When video encoder 20 encodes the video data, video encoder 20 may generate a bitstream. The bitstream may include a sequence of bits that form a coded representation of the video data. The bitstream may include coded pictures and associated data. A coded picture is a coded representation of a picture.

To generate the bitstream, video encoder 20 may perform encoding operations on each picture in the video data. When video encoder 20 performs encoding operations on the pictures, video encoder 20 may generate a series of coded pictures and associated data. The associated data may include video parameter sets (VPS), sequence parameter sets, picture parameter sets, adaptation parameter sets, and other syntax structures. A sequence parameter set (SPS) may contain parameters applicable to zero or more sequences of pictures. A picture parameter set (PPS) may contain parameters applicable to zero or more pictures. An adaptation parameter set (APS) may contain parameters applicable to zero or more pictures. Parameters in an APS may be parameters that are more likely to change than parameters in a PPS.

To generate a coded picture, video encoder 20 may partition a picture into equally-sized video blocks. A video block may be a two-dimensional array of samples. Each of the video blocks is associated with a treeblock. In some instances, a treeblock may be referred to as a largest coding unit (LCU). The treeblocks of HEVC may be broadly analogous to the macroblocks of previous standards, such as H.264/AVC. However, a treeblock is not necessarily limited to a particular size and may include one or more coding units (CUs). Video encoder 20 may use quadtree partitioning to partition the video blocks of treeblocks into video blocks associated with CUs, hence the name “treeblocks.”

In some examples, video encoder 20 may partition a picture into a plurality of slices. Each of the slices may include an integer number of CUs. In some instances, a slice comprises an integer number of treeblocks. In other instances, a boundary of a slice may be within a treeblock.

As part of performing an encoding operation on a picture, video encoder 20 may perform encoding operations on each slice of the picture. When video encoder 20 performs an encoding operation on a slice, video encoder 20 may generate encoded data associated with the slice. The encoded data associated with the slice may be referred to as a “coded slice.”

To generate a coded slice, video encoder 20 may perform encoding operations on each treeblock in a slice. When video encoder 20 performs an encoding operation on a treeblock, video encoder 20 may generate a coded treeblock. The coded treeblock may comprise data representing an encoded version of the treeblock.

When video encoder 20 generates a coded slice, video encoder 20 may perform encoding operations on (e.g., encode) the treeblocks in the slice according to a raster scan order. For example, video encoder 20 may encode the treeblocks of the slice in an order that proceeds from left to right across a topmost row of treeblocks in the slice, then from left to right across a next lower row of treeblocks, and so on until video encoder 20 has encoded each of the treeblocks in the slice.

As a result of encoding the treeblocks according to the raster scan order, the treeblocks above and to the left of a given treeblock may have been encoded, but treeblocks below and to the right of the given treeblock have not yet been encoded. Consequently, video encoder 20 may be able to access information generated by encoding treeblocks above and to the left of the given treeblock when encoding the given treeblock. However, video encoder 20 may be unable to access information generated by encoding treeblocks below and to the right of the given treeblock when encoding the given treeblock.

To generate a coded treeblock, video encoder 20 may recursively perform quadtree partitioning on the video block of the treeblock to divide the video block into progressively smaller video blocks. Each of the smaller video blocks may be associated with a different CU. For example, video encoder 20 may partition the video block of a treeblock into four equally-sized sub-blocks, partition one or more of the sub-blocks into four equally-sized sub-sub-blocks, and so on. A partitioned CU may be a CU whose video block is partitioned into video blocks associated with other CUs. A non-partitioned CU may be a CU whose video block is not partitioned into video blocks associated with other CUs.

One or more syntax elements in the bitstream may indicate a maximum number of times video encoder 20 may partition the video block of a treeblock. A video block of a CU may be square in shape. The size of the video block of a CU (e.g., the size of the CU) may range from 8×8 pixels up to the size of a video block of a treeblock (e.g., the size of the treeblock) with a maximum of 64×64 pixels or greater.

Video encoder 20 may perform encoding operations on (e.g., encode) each CU of a treeblock according to a z-scan order. In other words, video encoder 20 may encode a top-left CU, a top-right CU, a bottom-left CU, and then a bottom-right CU, in that order. When video encoder 20 performs an encoding operation on a partitioned CU, video encoder 20 may encode CUs associated with sub-blocks of the video block of the partitioned CU according to the z-scan order. In other words, video encoder 20 may encode a CU associated with a top-left sub-block, a CU associated with a top-right sub-block, a CU associated with a bottom-left sub-block, and then a CU associated with a bottom-right sub-block, in that order.

As a result of encoding the CUs of a treeblock according to a z-scan order, the CUs above, above-and-to-the-left, above-and-to-the-right, left, and below-and-to-the left of a given CU may have been encoded. CUs below and to the right of the given CU have not yet been encoded. Consequently, video encoder 20 may be able to access information generated by encoding some CUs that neighbor the given CU when encoding the given CU. However, video encoder 20 may be unable to access information generated by encoding other CUs that neighbor the given CU when encoding the given CU.

When video encoder 20 encodes a non-partitioned CU, video encoder 20 may generate one or more prediction units (PUs) for the CU. Each of the PUs of the CU may be associated with a different video block within the video block of the CU. Video encoder 20 may generate a predicted video block for each PU of the CU. The predicted video block of a PU may be a block of samples. Video encoder 20 may use intra prediction or inter prediction to generate the predicted video block for a PU.

When video encoder 20 uses intra prediction to generate the predicted video block of a PU, video encoder 20 may generate the predicted video block of the PU based on decoded samples of the picture associated with the PU. If video encoder 20 uses intra prediction to generate predicted video blocks of the PUs of a CU, the CU is an intra-predicted CU. When video encoder 20 uses inter prediction to generate the predicted video block of the PU, video encoder 20 may generate the predicted video block of the PU based on decoded samples of one or more pictures other than the picture associated with the PU. If video encoder 20 uses inter prediction to generate predicted video blocks of the PUs of a CU, the CU is an inter-predicted CU.

Furthermore, when video encoder 20 uses inter prediction to generate a predicted video block for a PU, video encoder 20 may generate motion information for the PU. The motion information for a PU may indicate one or more reference blocks of the PU. Each reference block of the PU may be a video block within a reference picture. The reference picture may be a picture other than the picture associated with the PU. In some instances, a reference block of a PU may also be referred to as the “reference sample” of the PU. Video encoder 20 may generate the predicted video block for the PU based on the reference blocks of the PU.

After video encoder 20 generates predicted video blocks for one or more PUs of a CU, video encoder 20 may generate residual data for the CU based on the predicted video blocks for the PUs of the CU. The residual data for the CU may indicate differences between samples in the predicted video blocks for the PUs of the CU and the original video block of the CU.

Furthermore, as part of performing an encoding operation on a non-partitioned CU, video encoder 20 may perform recursive quadtree partitioning on the residual data of the CU to partition the residual data of the CU into one or more blocks of residual data (e.g., residual video blocks) associated with transform units (TUs) of the CU. Each TU of a CU may be associated with a different residual video block.

Video encoder 20 may apply one or more transforms to residual video blocks associated with the TUs to generate transform coefficient blocks (e.g., blocks of transform coefficients) associated with the TUs. Conceptually, a transform coefficient block may be a two-dimensional (2D) matrix of transform coefficients.

After generating a transform coefficient block, video encoder 20 may perform a quantization process on the transform coefficient block. Quantization generally refers to a process in which transform coefficients are quantized to possibly reduce the amount of data used to represent the transform coefficients, providing further compression. The quantization process may reduce the bit depth associated with some or all of the transform coefficients. For example, an n-bit transform coefficient may be rounded down to an m-bit transform coefficient during quantization, where n is greater than m.

Video encoder 20 may associate each CU with a quantization parameter (QP) value. The QP value associated with a CU may determine how video encoder 20 quantizes transform coefficient blocks associated with the CU. Video encoder 20 may adjust the degree of quantization applied to the transform coefficient blocks associated with a CU by adjusting the QP value associated with the CU.

After video encoder 20 quantizes a transform coefficient block, video encoder 20 may generate sets of syntax elements that represent the transform coefficients in the quantized transform coefficient block. Video encoder 20 may apply entropy encoding operations, such as Context Adaptive Binary Arithmetic Coding (CABAC) operations, to some of these syntax elements. Other entropy coding techniques such as content adaptive variable length coding (CAVLC), probability interval partitioning entropy (PIPE) coding, or other binary arithmetic coding could also be used.

The bitstream generated by video encoder 20 may include a series of Network Abstraction Layer (NAL) units. Each of the NAL units may be a syntax structure containing an indication of a type of data in the NAL unit and bytes containing the data. For example, a NAL unit may contain data representing a video parameter set, a sequence parameter set, a picture parameter set, a coded slice, supplemental enhancement information (SEI), an access unit delimiter, filler data, or another type of data. The data in a NAL unit may include various syntax structures.

Video decoder 30 may receive the bitstream generated by video encoder 20. The bitstream may include a coded representation of the video data encoded by video encoder 20. When video decoder 30 receives the bitstream, video decoder 30 may perform a parsing operation on the bitstream. When video decoder 30 performs the parsing operation, video decoder 30 may extract syntax elements from the bitstream. Video decoder 30 may reconstruct the pictures of the video data based on the syntax elements extracted from the bitstream. The process to reconstruct the video data based on the syntax elements may be generally reciprocal to the process performed by video encoder 20 to generate the syntax elements.

After video decoder 30 extracts the syntax elements associated with a CU, video decoder 30 may generate predicted video blocks for the PUs of the CU based on the syntax elements. In addition, video decoder 30 may inverse quantize transform coefficient blocks associated with TUs of the CU. Video decoder 30 may perform inverse transforms on the transform coefficient blocks to reconstruct residual video blocks associated with the TUs of the CU. After generating the predicted video blocks and reconstructing the residual video blocks, video decoder 30 may reconstruct the video block of the CU based on the predicted video blocks and the residual video blocks. In this way, video decoder 30 may reconstruct the video blocks of CUs based on the syntax elements in the bitstream.

### Video Encoder

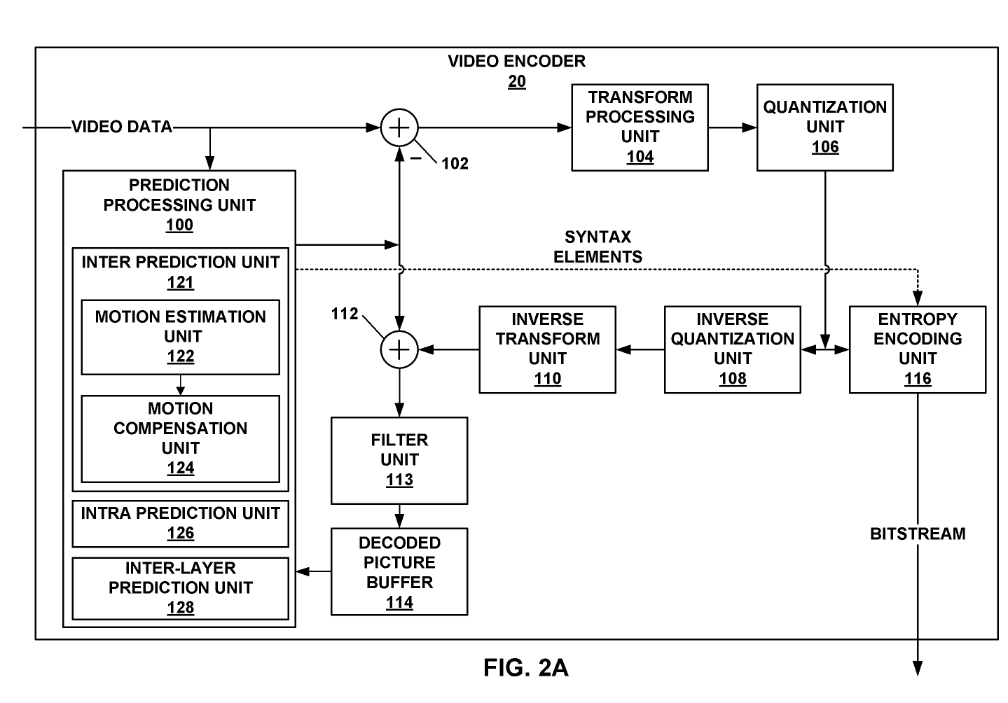

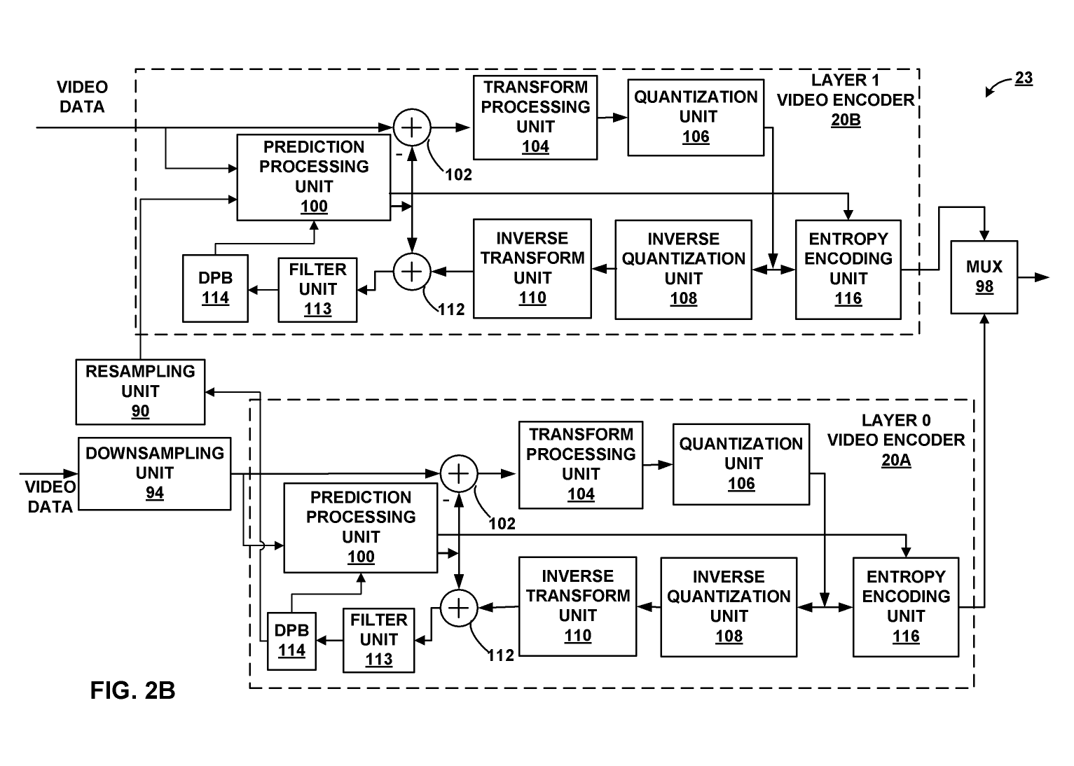

FIG. 2A is a block diagram illustrating an example of a video encoder that may implement techniques in accordance with aspects described in this disclosure. Video encoder 20 may be configured to process a single layer of a video frame, such as for HEVC. Further, video encoder 20 may be configured to perform any or all of the techniques of this disclosure. As one example, prediction processing unit 100 may be configured to perform any or all of the techniques described in this disclosure. In another embodiment, the video encoder 20 includes an optional inter-layer prediction unit 128 that is configured to perform any or all of the techniques described in this disclosure. In other embodiments, inter-layer prediction can be performed by prediction processing unit 100 (e.g., inter prediction unit 121 and/or intra prediction unit 126), in which case the inter-layer prediction unit 128 may be omitted. However, aspects of this disclosure are not so limited. In some examples, the techniques described in this disclosure may be shared among the various components of video encoder 20. In some examples, additionally or alternatively, a processor (not shown) may be configured to perform any or all of the techniques described in this disclosure.

For purposes of explanation, this disclosure describes video encoder 20 in the context of HEVC coding. However, the techniques of this disclosure may be applicable to other coding standards or methods. The example depicted in FIG. 2A is for a single layer codec. However, as will be described further with respect to FIG. 2B, some or all of the video encoder 20 may be duplicated for processing of a multi-layer codec.

Video encoder 20 may perform intra- and inter-coding of video blocks within video slices. Intra coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-directional prediction (B mode), may refer to any of several temporal-based coding modes.

In the example of FIG. 2A, video encoder 20 includes a plurality of functional components. The functional components of video encoder 20 include a prediction processing unit 100, a residual generation unit 102, a transform processing unit 104, a quantization unit 106, an inverse quantization unit 108, an inverse transform unit 110, a reconstruction unit 112, a filter unit 113, a decoded picture buffer 114, and an entropy encoding unit 116. Prediction processing unit 100 includes an inter prediction unit 121, a motion estimation unit 122, a motion compensation unit 124, an intra prediction unit 126, and an inter-layer prediction unit 128. In other examples, video encoder 20 may include more, fewer, or different functional components. Furthermore, motion estimation unit 122 and motion compensation unit 124 may be highly integrated, but are represented in the example of FIG. 2A separately for purposes of explanation.

Video encoder 20 may receive video data. Video encoder 20 may receive the video data from various sources. For example, video encoder 20 may receive the video data from video source 18 (e.g., shown in FIG. 1A or 1B) or another source. The video data may represent a series of pictures. To encode the video data, video encoder 20 may perform an encoding operation on each of the pictures. As part of performing the encoding operation on a picture, video encoder 20 may perform encoding operations on each slice of the picture. As part of performing an encoding operation on a slice, video encoder 20 may perform encoding operations on treeblocks in the slice.

As part of performing an encoding operation on a treeblock, prediction processing unit 100 may perform quadtree partitioning on the video block of the treeblock to divide the video block into progressively smaller video blocks. Each of the smaller video blocks may be associated with a different CU. For example, prediction processing unit 100 may partition a video block of a treeblock into four equally-sized sub-blocks, partition one or more of the sub-blocks into four equally-sized sub-sub-blocks, and so on.

The sizes of the video blocks associated with CUs may range from 8×8 samples up to the size of the treeblock with a maximum of 64×64 samples or greater. In this disclosure, “N×N” and “N by N” may be used interchangeably to refer to the sample dimensions of a video block in terms of vertical and horizontal dimensions, e.g., 16×16 samples or 16 by 16 samples. In general, a 16×16 video block has sixteen samples in a vertical direction (y=16) and sixteen samples in a horizontal direction (x=16). Likewise, an N×N block generally has N samples in a vertical direction and N samples in a horizontal direction, where N represents a nonnegative integer value.

Furthermore, as part of performing the encoding operation on a treeblock, prediction processing unit 100 may generate a hierarchical quadtree data structure for the treeblock. For example, a treeblock may correspond to a root node of the quadtree data structure. If prediction processing unit 100 partitions the video block of the treeblock into four sub-blocks, the root node has four child nodes in the quadtree data structure. Each of the child nodes corresponds to a CU associated with one of the sub-blocks. If prediction processing unit 100 partitions one of the sub-blocks into four sub-sub-blocks, the node corresponding to the CU associated with the sub-block may have four child nodes, each of which corresponds to a CU associated with one of the sub-sub-blocks.

Each node of the quadtree data structure may contain syntax data (e.g., syntax elements) for the corresponding treeblock or CU. For example, a node in the quadtree may include a split flag that indicates whether the video block of the CU corresponding to the node is partitioned (e.g., split) into four sub-blocks. Syntax elements for a CU may be defined recursively, and may depend on whether the video block of the CU is split into sub-blocks. A CU whose video block is not partitioned may correspond to a leaf node in the quadtree data structure. A coded treeblock may include data based on the quadtree data structure for a corresponding treeblock.

Video encoder 20 may perform encoding operations on each non-partitioned CU of a treeblock. When video encoder 20 performs an encoding operation on a non-partitioned CU, video encoder 20 generates data representing an encoded representation of the non-partitioned CU.

As part of performing an encoding operation on a CU, prediction processing unit 100 may partition the video block of the CU among one or more PUs of the CU. Video encoder 20 and video decoder 30 may support various PU sizes. Assuming that the size of a particular CU is 2N×2N, video encoder 20 and video decoder 30 may support PU sizes of 2N×2N or N×N, and inter-prediction in symmetric PU sizes of 2N×2N, 2N×N, N×2N, N×N, 2N×nU, nL×2N, nR×2N, or similar. Video encoder 20 and video decoder 30 may also support asymmetric partitioning for PU sizes of 2N×nU, 2N×nD, nL×2N, and nR×2N. In some examples, prediction processing unit 100 may perform geometric partitioning to partition the video block of a CU among PUs of the CU along a boundary that does not meet the sides of the video block of the CU at right angles.

Inter prediction unit 121 may perform inter prediction on each PU of the CU. Inter prediction may provide temporal compression. To perform inter prediction on a PU, motion estimation unit 122 may generate motion information for the PU. Motion compensation unit 124 may generate a predicted video block for the PU based the motion information and decoded samples of pictures other than the picture associated with the CU (e.g., reference pictures). In this disclosure, a predicted video block generated by motion compensation unit 124 may be referred to as an inter-predicted video block.

Slices may be I slices, P slices, or B slices. Motion estimation unit 122 and motion compensation unit 124 may perform different operations for a PU of a CU depending on whether the PU is in an I slice, a P slice, or a B slice. In an I slice, all PUs are intra predicted. Hence, if the PU is in an I slice, motion estimation unit 122 and motion compensation unit 124 do not perform inter prediction on the PU.

If the PU is in a P slice, the picture containing the PU is associated with a list of reference pictures referred to as “list 0.” Each of the reference pictures in list 0 contains samples that may be used for inter prediction of other pictures. When motion estimation unit 122 performs the motion estimation operation with regard to a PU in a P slice, motion estimation unit 122 may search the reference pictures in list 0 for a reference block for the PU. The reference block of the PU may be a set of samples, e.g., a block of samples, that most closely corresponds to the samples in the video block of the PU. Motion estimation unit 122 may use a variety of metrics to determine how closely a set of samples in a reference picture corresponds to the samples in the video block of a PU. For example, motion estimation unit 122 may determine how closely a set of samples in a reference picture corresponds to the samples in the video block of a PU by sum of absolute difference (SAD), sum of square difference (SSD), or other difference metrics.

After identifying a reference block of a PU in a P slice, motion estimation unit 122 may generate a reference index that indicates the reference picture in list 0 containing the reference block and a motion vector that indicates a spatial displacement between the PU and the reference block. In various examples, motion estimation unit 122 may generate motion vectors to varying degrees of precision. For example, motion estimation unit 122 may generate motion vectors at one-quarter sample precision, one-eighth sample precision, or other fractional sample precision. In the case of fractional sample precision, reference block values may be interpolated from integer-position sample values in the reference picture. Motion estimation unit 122 may output the reference index and the motion vector as the motion information of the PU. Motion compensation unit 124 may generate a predicted video block of the PU based on the reference block identified by the motion information of the PU.

If the PU is in a B slice, the picture containing the PU may be associated with two lists of reference pictures, referred to as “list 0” and “list 1.” In some examples, a picture containing a B slice may be associated with a list combination that is a combination of list 0 and list 1.

Furthermore, if the PU is in a B slice, motion estimation unit 122 may perform uni-directional prediction or bi-directional prediction for the PU. When motion estimation unit 122 performs uni-directional prediction for the PU, motion estimation unit 122 may search the reference pictures of list 0 or list 1 for a reference block for the PU. Motion estimation unit 122 may then generate a reference index that indicates the reference picture in list 0 or list 1 that contains the reference block and a motion vector that indicates a spatial displacement between the PU and the reference block. Motion estimation unit 122 may output the reference index, a prediction direction indicator, and the motion vector as the motion information of the PU. The prediction direction indicator may indicate whether the reference index indicates a reference picture in list 0 or list 1. Motion compensation unit 124 may generate the predicted video block of the PU based on the reference block indicated by the motion information of the PU.

When motion estimation unit 122 performs bi-directional prediction for a PU, motion estimation unit 122 may search the reference pictures in list 0 for a reference block for the PU and may also search the reference pictures in list 1 for another reference block for the PU. Motion estimation unit 122 may then generate reference indexes that indicate the reference pictures in list 0 and list 1 containing the reference blocks and motion vectors that indicate spatial displacements between the reference blocks and the PU. Motion estimation unit 122 may output the reference indexes and the motion vectors of the PU as the motion information of the PU. Motion compensation unit 124 may generate the predicted video block of the PU based on the reference blocks indicated by the motion information of the PU.

In some instances, motion estimation unit 122 does not output a full set of motion information for a PU to entropy encoding unit 116. Rather, motion estimation unit 122 may signal the motion information of a PU with reference to the motion information of another PU. For example, motion estimation unit 122 may determine that the motion information of the PU is sufficiently similar to the motion information of a neighboring PU. In this example, motion estimation unit 122 may indicate, in a syntax structure associated with the PU, a value that indicates to video decoder 30 that the PU has the same motion information as the neighboring PU. In another example, motion estimation unit 122 may identify, in a syntax structure associated with the PU, a neighboring PU and a motion vector difference (MVD). The motion vector difference indicates a difference between the motion vector of the PU and the motion vector of the indicated neighboring PU. Video decoder 30 may use the motion vector of the indicated neighboring PU and the motion vector difference to determine the motion vector of the PU. By referring to the motion information of a first PU when signaling the motion information of a second PU, video encoder 20 may be able to signal the motion information of the second PU using fewer bits.

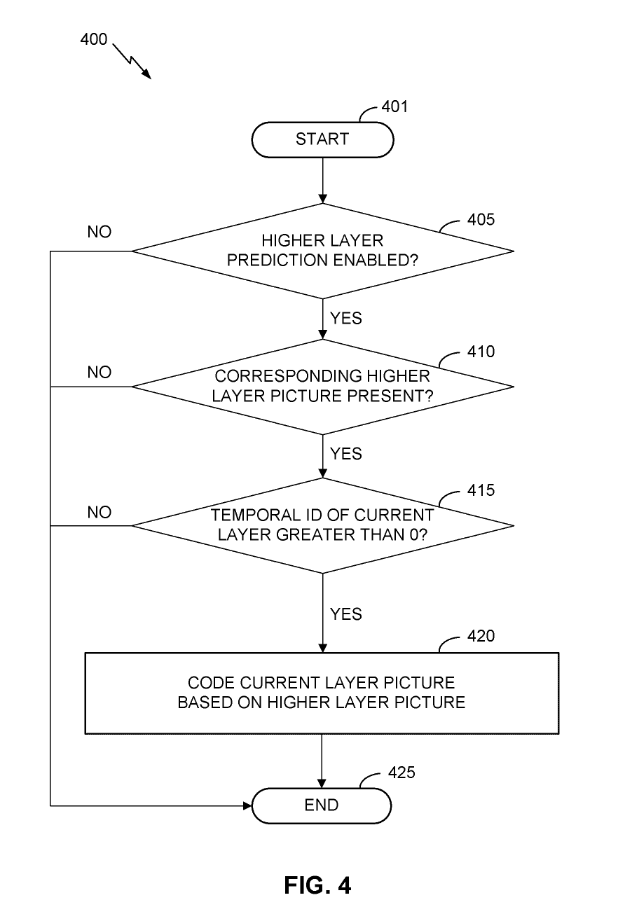

As further discussed below with reference to FIG. 4, the prediction processing unit 100 may be configured to code (e.g., encode or decode) the PU (or any other reference layer and/or enhancement layer blocks or video units) by performing the methods illustrated in FIG. 4. For example, inter prediction unit 121 (e.g., via motion estimation unit 122 and/or motion compensation unit 124), intra prediction unit 126, or inter-layer prediction unit 128 may be configured to perform the methods illustrated in FIG. 4, either together or separately.

As part of performing an encoding operation on a CU, intra prediction unit 126 may perform intra prediction on PUs of the CU. Intra prediction may provide spatial compression. When intra prediction unit 126 performs intra prediction on a PU, intra prediction unit 126 may generate prediction data for the PU based on decoded samples of other PUs in the same picture. The prediction data for the PU may include a predicted video block and various syntax elements. Intra prediction unit 126 may perform intra prediction on PUs in I slices, P slices, and B slices.

To perform intra prediction on a PU, intra prediction unit 126 may use multiple intra prediction modes to generate multiple sets of prediction data for the PU. When intra prediction unit 126 uses an intra prediction mode to generate a set of prediction data for the PU, intra prediction unit 126 may extend samples from video blocks of neighboring PUs across the video block of the PU in a direction and/or gradient associated with the intra prediction mode. The neighboring PUs may be above, above and to the right, above and to the left, or to the left of the PU, assuming a left-to-right, top-to-bottom encoding order for PUs, CUs, and treeblocks. Intra prediction unit 126 may use various numbers of intra prediction modes, e.g., 33 directional intra prediction modes, depending on the size of the PU.

Prediction processing unit 100 may select the prediction data for a PU from among the prediction data generated by motion compensation unit 124 for the PU or the prediction data generated by intra prediction unit 126 for the PU. In some examples, prediction processing unit 100 selects the prediction data for the PU based on rate/distortion metrics of the sets of prediction data.

If prediction processing unit 100 selects prediction data generated by intra prediction unit 126, prediction processing unit 100 may signal the intra prediction mode that was used to generate the prediction data for the PUs, e.g., the selected intra prediction mode. Prediction processing unit 100 may signal the selected intra prediction mode in various ways. For example, it is probable the selected intra prediction mode is the same as the intra prediction mode of a neighboring PU. In other words, the intra prediction mode of the neighboring PU may be the most probable mode for the current PU. Thus, prediction processing unit 100 may generate a syntax element to indicate that the selected intra prediction mode is the same as the intra prediction mode of the neighboring PU.

As discussed above, the video encoder 20 may include inter-layer prediction unit 128. Inter-layer prediction unit 128 is configured to predict a current block (e.g., a current block in the EL) using one or more different layers that are available in SVC (e.g., a base or reference layer). Such prediction may be referred to as inter-layer prediction. Inter-layer prediction unit 128 utilizes prediction methods to reduce inter-layer redundancy, thereby improving coding efficiency and reducing computational resource requirements. Some examples of inter-layer prediction include inter-layer intra prediction, inter-layer motion prediction, and inter-layer residual prediction. Inter-layer intra prediction uses the reconstruction of co-located blocks in the base layer to predict the current block in the enhancement layer. Inter-layer motion prediction uses motion information of the base layer to predict motion in the enhancement layer. Inter-layer residual prediction uses the residue of the base layer to predict the residue of the enhancement layer. Each of the inter-layer prediction schemes is discussed below in greater detail.

After prediction processing unit 100 selects the prediction data for PUs of a CU, residual generation unit 102 may generate residual data for the CU by subtracting (e.g., indicated by the minus sign) the predicted video blocks of the PUs of the CU from the video block of the CU. The residual data of a CU may include 2D residual video blocks that correspond to different sample components of the samples in the video block of the CU. For example, the residual data may include a residual video block that corresponds to differences between luminance components of samples in the predicted video blocks of the PUs of the CU and luminance components of samples in the original video block of the CU. In addition, the residual data of the CU may include residual video blocks that correspond to the differences between chrominance components of samples in the predicted video blocks of the PUs of the CU and the chrominance components of the samples in the original video block of the CU.

Prediction processing unit 100 may perform quadtree partitioning to partition the residual video blocks of a CU into sub-blocks. Each undivided residual video block may be associated with a different TU of the CU. The sizes and positions of the residual video blocks associated with TUs of a CU may or may not be based on the sizes and positions of video blocks associated with the PUs of the CU. A quadtree structure known as a “residual quad tree” (RQT) may include nodes associated with each of the residual video blocks. The TUs of a CU may correspond to leaf nodes of the RQT.

Transform processing unit 104 may generate one or more transform coefficient blocks for each TU of a CU by applying one or more transforms to a residual video block associated with the TU. Each of the transform coefficient blocks may be a 2D matrix of transform coefficients. Transform processing unit 104 may apply various transforms to the residual video block associated with a TU. For example, transform processing unit 104 may apply a discrete cosine transform (DCT), a directional transform, or a conceptually similar transform to the residual video block associated with a TU.

After transform processing unit 104 generates a transform coefficient block associated with a TU, quantization unit 106 may quantize the transform coefficients in the transform coefficient block. Quantization unit 106 may quantize a transform coefficient block associated with a TU of a CU based on a QP value associated with the CU.

Video encoder 20 may associate a QP value with a CU in various ways. For example, video encoder 20 may perform a rate-distortion analysis on a treeblock associated with the CU. In the rate-distortion analysis, video encoder 20 may generate multiple coded representations of the treeblock by performing an encoding operation multiple times on the treeblock. Video encoder 20 may associate different QP values with the CU when video encoder 20 generates different encoded representations of the treeblock. Video encoder 20 may signal that a given QP value is associated with the CU when the given QP value is associated with the CU in a coded representation of the treeblock that has a lowest bitrate and distortion metric.

Inverse quantization unit 108 and inverse transform unit 110 may apply inverse quantization and inverse transforms to the transform coefficient block, respectively, to reconstruct a residual video block from the transform coefficient block. Reconstruction unit 112 may add the reconstructed residual video block to corresponding samples from one or more predicted video blocks generated by prediction processing unit 100 to produce a reconstructed video block associated with a TU. By reconstructing video blocks for each TU of a CU in this way, video encoder 20 may reconstruct the video block of the CU.

After reconstruction unit 112 reconstructs the video block of a CU, filter unit 113 may perform a deblocking operation to reduce blocking artifacts in the video block associated with the CU. After performing the one or more deblocking operations, filter unit 113 may store the reconstructed video block of the CU in decoded picture buffer 114. Motion estimation unit 122 and motion compensation unit 124 may use a reference picture that contains the reconstructed video block to perform inter prediction on PUs of subsequent pictures. In addition, intra prediction unit 126 may use reconstructed video blocks in decoded picture buffer 114 to perform intra prediction on other PUs in the same picture as the CU.

Entropy encoding unit 116 may receive data from other functional components of video encoder 20. For example, entropy encoding unit 116 may receive transform coefficient blocks from quantization unit 106 and may receive syntax elements from prediction processing unit 100. When entropy encoding unit 116 receives the data, entropy encoding unit 116 may perform one or more entropy encoding operations to generate entropy encoded data. For example, video encoder 20 may perform a context adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, or another type of entropy encoding operation on the data. Entropy encoding unit 116 may output a bitstream that includes the entropy encoded data.

As part of performing an entropy encoding operation on data, entropy encoding unit 116 may select a context model. If entropy encoding unit 116 is performing a CABAC operation, the context model may indicate estimates of probabilities of particular bins having particular values. In the context of CABAC, the term “bin” is used to refer to a bit of a binarized version of a syntax element.

### Multi-Layer Video Encoder

FIG. 2B is a block diagram illustrating an example of a multi-layer video encoder 23 that may implement techniques in accordance with aspects described in this disclosure. The video encoder 23 may be configured to process multi-layer video frames, such as for SHVC and multiview coding. Further, the video encoder 23 may be configured to perform any or all of the techniques of this disclosure.

The video encoder 23 includes a video encoder 20A and video encoder 20B, each of which may be configured as the video encoder 20 and may perform the functions described above with respect to the video encoder 20. Further, as indicated by the reuse of reference numbers, the video encoders 20A and 20B may include at least some of the systems and subsystems as the video encoder 20. Although the video encoder 23 is illustrated as including two video encoders 20A and 20B, the video encoder 23 is not limited as such and may include any number of video encoder 20 layers. In some embodiments, the video encoder 23 may include a video encoder 20 for each picture or frame in an access unit. For example, an access unit that includes five pictures may be processed or encoded by a video encoder that includes five encoder layers. In some embodiments, the video encoder 23 may include more encoder layers than frames in an access unit. In some such cases, some of the video encoder layers may be inactive when processing some access units.

In addition to the video encoders 20A and 20B, the video encoder 23 may include an resampling unit 90. The resampling unit 90 may, in some cases, upsample a base layer of a received video frame to, for example, create an enhancement layer. The resampling unit 90 may upsample particular information associated with the received base layer of a frame, but not other information. For example, the resampling unit 90 may upsample the spatial size or number of pixels of the base layer, but the number of slices or the picture order count may remain constant. In some cases, the resampling unit 90 may not process the received video and/or may be optional. For example, in some cases, the prediction processing unit 100 may perform upsampling. In some embodiments, the resampling unit 90 is configured to upsample a layer and reorganize, redefine, modify, or adjust one or more slices to comply with a set of slice boundary rules and/or raster scan rules. Although primarily described as upsampling a base layer, or a lower layer in an access unit, in some cases, the resampling unit 90 may downsample a layer. For example, if during streaming of a video bandwidth is reduced, a frame may be downsampled instead of upsampled.

The resampling unit 90 may be configured to receive a picture or frame (or picture information associated with the picture) from the decoded picture buffer 114 of the lower layer encoder (e.g., the video encoder 20A) and to upsample the picture (or the received picture information). This upsampled picture may then be provided to the prediction processing unit 100 of a higher layer encoder (e.g., the video encoder 20B) configured to encode a picture in the same access unit as the lower layer encoder. In some cases, the higher layer encoder is one layer removed from the lower layer encoder. In other cases, there may be one or more higher layer encoders between the layer 0 video encoder and the layer 1 encoder of FIG. 2B.

In some cases, the resampling unit 90 may be omitted or bypassed. In such cases, the picture from the decoded picture buffer 114 of the video encoder 20A may be provided directly, or at least without being provided to the resampling unit 90, to the prediction processing unit 100 of the video encoder 20B. For example, if video data provided to the video encoder 20B and the reference picture from the decoded picture buffer 114 of the video encoder 20A are of the same size or resolution, the reference picture may be provided to the video encoder 20B without any resampling.

In some embodiments, the video encoder 23 downsamples video data to be provided to the lower layer encoder using the downsampling unit 94 before provided the video data to the video encoder 20A. Alternatively, the downsampling unit 94 may be a resampling unit 90 capable of upsampling or downsampling the video data. In yet other embodiments, the downsampling unit 94 may be omitted.

As illustrated in FIG. 2B, the video encoder 23 may further include a multiplexor 98, or mux. The mux 98 can output a combined bitstream from the video encoder 23. The combined bitstream may be created by taking a bitstream from each of the video encoders 20A and 20B and alternating which bitstream is output at a given time. While in some cases the bits from the two (or more in the case of more than two video encoder layers) bitstreams may be alternated one bit at a time, in many cases the bitstreams are combined differently. For example, the output bitstream may be created by alternating the selected bitstream one block at a time. In another example, the output bitstream may be created by outputting a non-1:1 ratio of blocks from each of the video encoders 20A and 20B. For instance, two blocks may be output from the video encoder 20B for each block output from the video encoder 20A. In some embodiments, the output stream from the mux 98 may be preprogrammed. In other embodiments, the mux 98 may combine the bitstreams from the video encoders 20A, 20B based on a control signal received from a system external to the video encoder 23, such as from a processor on a source device including the source module 12. The control signal may be generated based on the resolution or bitrate of a video from the video source 18, based on a bandwidth of the link 16, based on a subscription associated with a user (e.g., a paid subscription versus a free subscription), or based on any other factor for determining a resolution output desired from the video encoder 23.

### Video Decoder

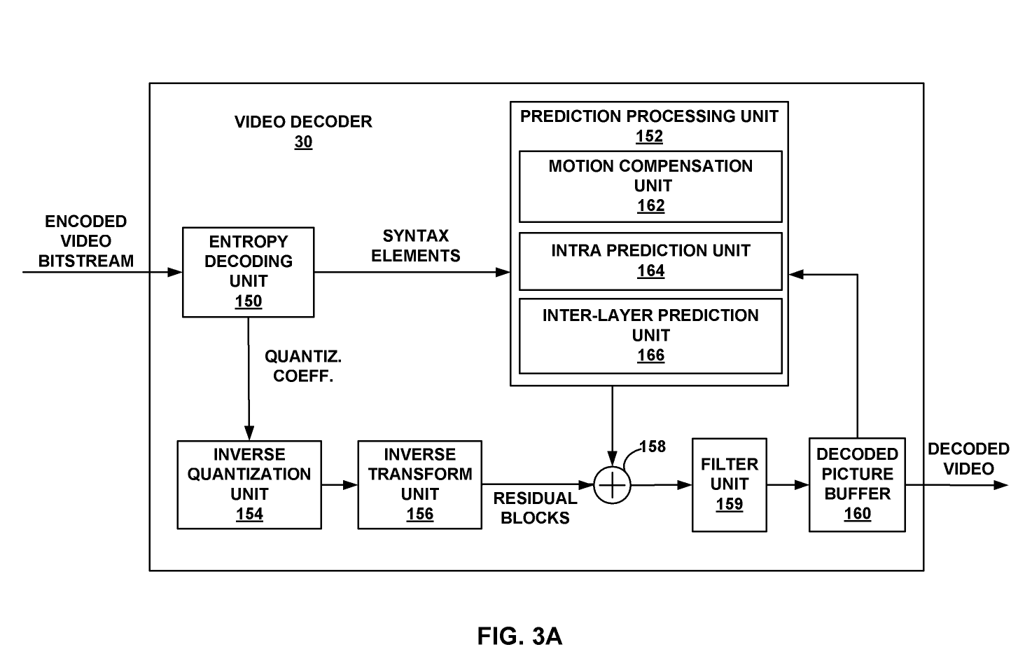

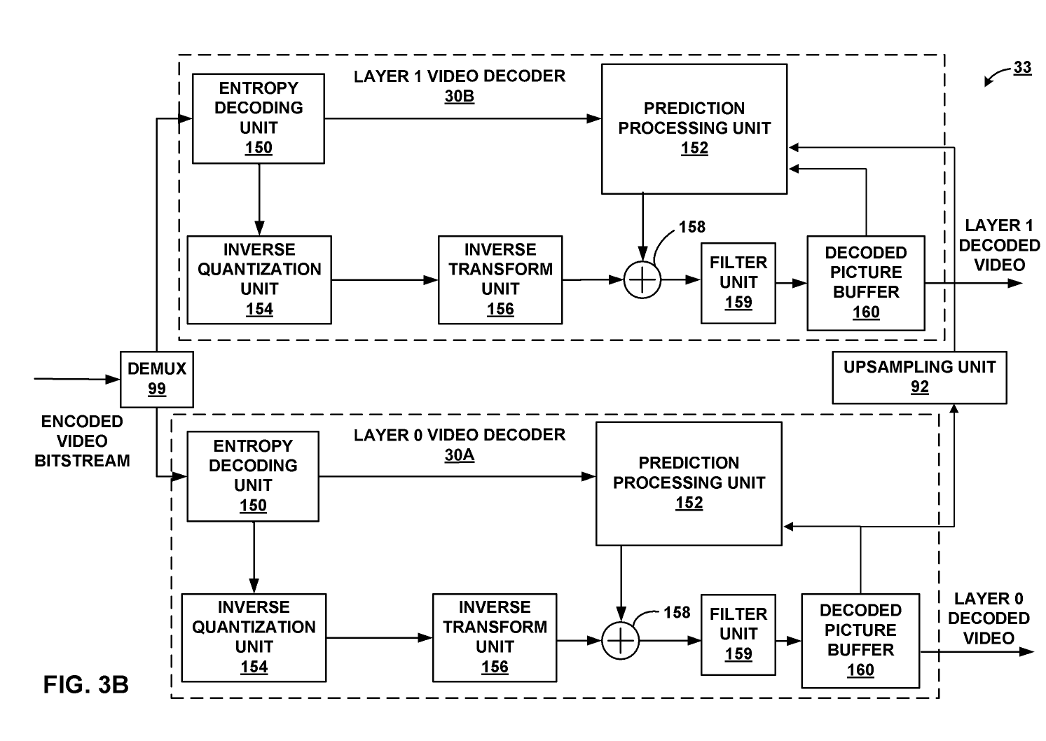

FIG. 3A is a block diagram illustrating an example of a video decoder that may implement techniques in accordance with aspects described in this disclosure. The video decoder 30 may be configured to process a single layer of a video frame, such as for HEVC. Further, video decoder 30 may be configured to perform any or all of the techniques of this disclosure. As one example, motion compensation unit 162 and/or intra prediction unit 164 may be configured to perform any or all of the techniques described in this disclosure. In one embodiment, video decoder 30 may optionally include inter-layer prediction unit 166 that is configured to perform any or all of the techniques described in this disclosure. In other embodiments, inter-layer prediction can be performed by prediction processing unit 152 (e.g., motion compensation unit 162 and/or intra prediction unit 164), in which case the inter-layer prediction unit 166 may be omitted. However, aspects of this disclosure are not so limited. In some examples, the techniques described in this disclosure may be shared among the various components of video decoder 30. In some examples, additionally or alternatively, a processor (not shown) may be configured to perform any or all of the techniques described in this disclosure.

For purposes of explanation, this disclosure describes video decoder 30 in the context of HEVC coding. However, the techniques of this disclosure may be applicable to other coding standards or methods. The example depicted in FIG. 3A is for a single layer codec. However, as will be described further with respect to FIG. 3B, some or all of the video decoder 30 may be duplicated for processing of a multi-layer codec.

In the example of FIG. 3A, video decoder 30 includes a plurality of functional components. The functional components of video decoder 30 include an entropy decoding unit 150, a prediction processing unit 152, an inverse quantization unit 154, an inverse transform unit 156, a reconstruction unit 158, a filter unit 159, and a decoded picture buffer 160. Prediction processing unit 152 includes a motion compensation unit 162, an intra prediction unit 164, and an inter-layer prediction unit 166. In some examples, video decoder 30 may perform a decoding pass generally reciprocal to the encoding pass described with respect to video encoder 20 of FIG. 2A. In other examples, video decoder 30 may include more, fewer, or different functional components.

Video decoder 30 may receive a bitstream that comprises encoded video data. The bitstream may include a plurality of syntax elements. When video decoder 30 receives the bitstream, entropy decoding unit 150 may perform a parsing operation on the bitstream. As a result of performing the parsing operation on the bitstream, entropy decoding unit 150 may extract syntax elements from the bitstream. As part of performing the parsing operation, entropy decoding unit 150 may entropy decode entropy encoded syntax elements in the bitstream. Prediction processing unit 152, inverse quantization unit 154, inverse transform unit 156, reconstruction unit 158, and filter unit 159 may perform a reconstruction operation that generates decoded video data based on the syntax elements extracted from the bitstream.

As discussed above, the bitstream may comprise a series of NAL units. The NAL units of the bitstream may include video parameter set NAL units, sequence parameter set NAL units, picture parameter set NAL units, SEI NAL units, and so on. As part of performing the parsing operation on the bitstream, entropy decoding unit 150 may perform parsing operations that extract and entropy decode sequence parameter sets from sequence parameter set NAL units, picture parameter sets from picture parameter set NAL units, SEI data from SEI NAL units, and so on.

In addition, the NAL units of the bitstream may include coded slice NAL units. As part of performing the parsing operation on the bitstream, entropy decoding unit 150 may perform parsing operations that extract and entropy decode coded slices from the coded slice NAL units. Each of the coded slices may include a slice header and slice data. The slice header may contain syntax elements pertaining to a slice. The syntax elements in the slice header may include a syntax element that identifies a picture parameter set associated with a picture that contains the slice. Entropy decoding unit 150 may perform entropy decoding operations, such as CABAC decoding operations, on syntax elements in the coded slice header to recover the slice header.

As part of extracting the slice data from coded slice NAL units, entropy decoding unit 150 may perform parsing operations that extract syntax elements from coded CUs in the slice data. The extracted syntax elements may include syntax elements associated with transform coefficient blocks. Entropy decoding unit 150 may then perform CABAC decoding operations on some of the syntax elements.

After entropy decoding unit 150 performs a parsing operation on a non-partitioned CU, video decoder 30 may perform a reconstruction operation on the non-partitioned CU. To perform the reconstruction operation on a non-partitioned CU, video decoder 30 may perform a reconstruction operation on each TU of the CU. By performing the reconstruction operation for each TU of the CU, video decoder 30 may reconstruct a residual video block associated with the CU.

As part of performing a reconstruction operation on a TU, inverse quantization unit 154 may inverse quantize, e.g., de-quantize, a transform coefficient block associated with the TU. Inverse quantization unit 154 may inverse quantize the transform coefficient block in a manner similar to the inverse quantization processes proposed for HEVC or defined by the H.264 decoding standard. Inverse quantization unit 154 may use a quantization parameter QP calculated by video encoder 20 for a CU of the transform coefficient block to determine a degree of quantization and, likewise, a degree of inverse quantization for inverse quantization unit 154 to apply.

After inverse quantization unit 154 inverse quantizes a transform coefficient block, inverse transform unit 156 may generate a residual video block for the TU associated with the transform coefficient block. Inverse transform unit 156 may apply an inverse transform to the transform coefficient block in order to generate the residual video block for the TU. For example, inverse transform unit 156 may apply an inverse DCT, an inverse integer transform, an inverse Karhunen-Loeve transform (KLT), an inverse rotational transform, an inverse directional transform, or another inverse transform to the transform coefficient block. In some examples, inverse transform unit 156 may determine an inverse transform to apply to the transform coefficient block based on signaling from video encoder 20. In such examples, inverse transform unit 156 may determine the inverse transform based on a signaled transform at the root node of a quadtree for a treeblock associated with the transform coefficient block. In other examples, inverse transform unit 156 may infer the inverse transform from one or more coding characteristics, such as block size, coding mode, or the like. In some examples, inverse transform unit 156 may apply a cascaded inverse transform.

In some examples, motion compensation unit 162 may refine the predicted video block of a PU by performing interpolation based on interpolation filters. Identifiers for interpolation filters to be used for motion compensation with sub-sample precision may be included in the syntax elements. Motion compensation unit 162 may use the same interpolation filters used by video encoder 20 during generation of the predicted video block of the PU to calculate interpolated values for sub-integer samples of a reference block. Motion compensation unit 162 may determine the interpolation filters used by video encoder 20 according to received syntax information and use the interpolation filters to produce the predicted video block.

As further discussed below with reference to FIG. 4, the prediction processing unit 152 may code (e.g., encode or decode) the PU (or any other reference layer and/or enhancement layer blocks or video units) by performing the methods illustrated in FIG. 4. For example, motion compensation unit 162, intra prediction unit 164, or inter-layer prediction unit 166 may be configured to perform the methods illustrated in FIG. 4, either together or separately.

If a PU is encoded using intra prediction, intra prediction unit 164 may perform intra prediction to generate a predicted video block for the PU. For example, intra prediction unit 164 may determine an intra prediction mode for the PU based on syntax elements in the bitstream. The bitstream may include syntax elements that intra prediction unit 164 may use to determine the intra prediction mode of the PU.

In some instances, the syntax elements may indicate that intra prediction unit 164 is to use the intra prediction mode of another PU to determine the intra prediction mode of the current PU. For example, it may be probable that the intra prediction mode of the current PU is the same as the intra prediction mode of a neighboring PU. In other words, the intra prediction mode of the neighboring PU may be the most probable mode for the current PU. Hence, in this example, the bitstream may include a small syntax element that indicates that the intra prediction mode of the PU is the same as the intra prediction mode of the neighboring PU. Intra prediction unit 164 may then use the intra prediction mode to generate prediction data (e.g., predicted samples) for the PU based on the video blocks of spatially neighboring PUs.

As discussed above, video decoder 30 may also include inter-layer prediction unit 166. Inter-layer prediction unit 166 is configured to predict a current block (e.g., a current block in the EL) using one or more different layers that are available in SVC (e.g., a base or reference layer). Such prediction may be referred to as inter-layer prediction. Inter-layer prediction unit 166 utilizes prediction methods to reduce inter-layer redundancy, thereby improving coding efficiency and reducing computational resource requirements. Some examples of inter-layer prediction include inter-layer intra prediction, inter-layer motion prediction, and inter-layer residual prediction. Inter-layer intra prediction uses the reconstruction of co-located blocks in the base layer to predict the current block in the enhancement layer. Inter-layer motion prediction uses motion information of the base layer to predict motion in the enhancement layer. Inter-layer residual prediction uses the residue of the base layer to predict the residue of the enhancement layer. Each of the inter-layer prediction schemes is discussed below in greater detail.

Reconstruction unit 158 may use the residual video blocks associated with TUs of a CU and the predicted video blocks of the PUs of the CU, e.g., either intra-prediction data or inter-prediction data, as applicable, to reconstruct the video block of the CU. Thus, video decoder 30 may generate a predicted video block and a residual video block based on syntax elements in the bitstream and may generate a video block based on the predicted video block and the residual video block.

After reconstruction unit 158 reconstructs the video block of the CU, filter unit 159 may perform a deblocking operation to reduce blocking artifacts associated with the CU. After filter unit 159 performs a deblocking operation to reduce blocking artifacts associated with the CU, video decoder 30 may store the video block of the CU in decoded picture buffer 160. Decoded picture buffer 160 may provide reference pictures for subsequent motion compensation, intra prediction, and presentation on a display device, such as display device 32 of FIG. 1A or 1B. For instance, video decoder 30 may perform, based on the video blocks in decoded picture buffer 160, intra prediction or inter prediction operations on PUs of other CUs.

### Multi-Layer Decoder

FIG. 3B is a block diagram illustrating an example of a multi-layer video decoder 33 that may implement techniques in accordance with aspects described in this disclosure. The video decoder 33 may be configured to process multi-layer video frames, such as for SHVC and multiview coding. Further, the video decoder 33 may be configured to perform any or all of the techniques of this disclosure.

The video decoder 33 includes a video decoder 30A and video decoder 30B, each of which may be configured as the video decoder 30 and may perform the functions described above with respect to the video decoder 30. Further, as indicated by the reuse of reference numbers, the video decoders 30A and 30B may include at least some of the systems and subsystems as the video decoder 30. Although the video decoder 33 is illustrated as including two video decoders 30A and 30B, the video decoder 33 is not limited as such and may include any number of video decoder 30 layers. In some embodiments, the video decoder 33 may include a video decoder 30 for each picture or frame in an access unit. For example, an access unit that includes five pictures may be processed or decoded by a video decoder that includes five decoder layers. In some embodiments, the video decoder 33 may include more decoder layers than frames in an access unit. In some such cases, some of the video decoder layers may be inactive when processing some access units.

In addition to the video decoders 30A and 30B, the video decoder 33 may include an upsampling unit 92. In some embodiments, the upsampling unit 92 may upsample a base layer of a received video frame to create an enhanced layer to be added to the reference picture list for the frame or access unit. This enhanced layer can be stored in the decoded picture buffer 160. In some embodiments, the upsampling unit 92 can include some or all of the embodiments described with respect to the resampling unit 90 of FIG. 2A. In some embodiments, the upsampling unit 92 is configured to upsample a layer and reorganize, redefine, modify, or adjust one or more slices to comply with a set of slice boundary rules and/or raster scan rules. In some cases, the upsampling unit 92 may be a resampling unit configured to upsample and/or downsample a layer of a received video frame

The upsampling unit 92 may be configured to receive a picture or frame (or picture information associated with the picture) from the decoded picture buffer 160 of the lower layer decoder (e.g., the video decoder 30A) and to upsample the picture (or the received picture information). This upsampled picture may then be provided to the prediction processing unit 152 of a higher layer decoder (e.g., the video decoder 30B) configured to decode a picture in the same access unit as the lower layer decoder. In some cases, the higher layer decoder is one layer removed from the lower layer decoder. In other cases, there may be one or more higher layer decoders between the layer 0 decoder and the layer 1 decoder of FIG. 3B.

In some cases, the upsampling unit 92 may be omitted or bypassed. In such cases, the picture from the decoded picture buffer 160 of the video decoder 30A may be provided directly, or at least without being provided to the upsampling unit 92, to the prediction processing unit 152 of the video decoder 30B. For example, if video data provided to the video decoder 30B and the reference picture from the decoded picture buffer 160 of the video decoder 30A are of the same size or resolution, the reference picture may be provided to the video decoder 30B without upsampling. Further, in some embodiments, the upsampling unit 92 may be a resampling unit 90 configured to upsample or downsample a reference picture received from the decoded picture buffer 160 of the video decoder 30A.

As illustrated in FIG. 3B, the video decoder 33 may further include a demultiplexor 99, or demux. The demux 99 can split an encoded video bitstream into multiple bitstreams with each bitstream output by the demux 99 being provided to a different video decoder 30A and 30B. The multiple bitstreams may be created by receiving a bitstream and each of the video decoders 30A and 30B receives a portion of the bitstream at a given time. While in some cases the bits from the bitstream received at the demux 99 may be alternated one bit at a time between each of the video decoders (e.g., video decoders 30A and 30B in the example of FIG. 3B), in many cases the bitstream is divided differently. For example, the bitstream may be divided by alternating which video decoder receives the bitstream one block at a time. In another example, the bitstream may be divided by a non-1:1 ratio of blocks to each of the video decoders 30A and 30B. For instance, two blocks may be provided to the video decoder 30B for each block provided to the video decoder 30A. In some embodiments, the division of the bitstream by the demux 99 may be preprogrammed. In other embodiments, the demux 99 may divide the bitstream based on a control signal received from a system external to the video decoder 33, such as from a processor on a destination device including the destination module 14. The control signal may be generated based on the resolution or bitrate of a video from the input interface 28, based on a bandwidth of the link 16, based on a subscription associated with a user (e.g., a paid subscription versus a free subscription), or based on any other factor for determining a resolution obtainable by the video decoder 33.

Coding Efficiency Vs. Drift

As discussed above, a drift occurs when any portion of the EL that is used to code the BL is missing. For example, if the decoder processes a bitstream containing two layers, BL and EL, where the BL is coded using information contained in the EL, and the decoder chooses to decode only the BL portion of the bitstream, a drift would occur because the information used to code the BL is no longer available.

### Minimizing Drift

In one implementation, EL pictures may be coded using information in the BL, but BL pictures may not be coded using information in the EL. In such an example, even if a portion of the EL is lost, decoding of the BL is not affected because the BL is not coded based on the EL.

In another implementation, “key pictures” are designated throughout the bitstream, and such key pictures can only use information in the BL. Thus, even if a portion of the EL is lost, at least these key pictures are not affected by the drift. In this implementation, coding efficiency may be improved by allowing BL pictures to be coded based on EL pictures, but by having these key pictures, which may also be referred to as refresh pictures, the adverse effects of a drift may be significantly reduced.

### Existing Coding Schemes

Some implementations (e.g., HEVC) may not allow lower layers to be coded using higher layer decoded pictures as reference pictures. Also, some implementations may not have any mechanism for indicating that a higher layer decoded picture is a reference picture of a current picture in a lower layer. In such implementations, techniques described in the present disclosure may be utilized to exploit the coding efficiency gain resulting from allowing a lower layer (e.g., BL) to be coded based on a higher layer (e.g., EL) while minimizing the adverse effects associated with drift.

### Examples Embodiments

In the present disclosure, various example embodiments are described for signaling and processing indications of whether higher layer decoded pictures may be used as reference pictures for coding lower layer pictures. One or more of such embodiments may be described in connection with an existing implementation (e.g., HEVC extensions). The embodiments of the present disclosure can be applied independently from each other or in combination, and may be applicable or extended to scalable coding, multi-view coding with or without depth, and other extensions to HEVC and other video codecs.

Although the example of a BL and an EL is used to describe some embodiments, the techniques described herein may be applied and extended to any pair or group of layers such as an RL and an EL, a BL and multiple ELs, an RL and multiple ELs, etc.

### VPS Level Signal Indication of Using Higher Layer Decoded Pictures

In one embodiment, a flag or syntax element provided in the video parameter set (VPS) indicates whether higher layer decoded pictures may be used as reference pictures for coding lower layer pictures. Since the flag or syntax element is provided in the VPS, any indication provided by the flag or syntax element would apply to all layers in the same coded video sequence (CVS). Below is an example syntax illustrating the implementation of such a flag or syntax element. The relevant portions are shown in italics.

TABLE 1
Example syntax illustrating enable_higher_layer_ref_pic_pred

| vps_extension( ) { | Descriptor |
|---|---|
| while( !byte_aligned( ) ) | |
| vps_extension_byte_alignment_reserved_one_bit | u(1) |
| ....... | |
| for( i = 0; i <= vps_max_layers_minus1 − 1; i++ ) | |
| enable_higher_layer_ref_pic_pred[ i ] | u(1) |
| ...... | |
| } | |

### Example Semantics #1

For example, the following semantics may be used to define the flag or syntax element: enable_higher_layer_ref_pic_pred[i] equal to 0 specifies that within the CVS, the decoded pictures with nuh_layer_id greater than layer_id_in_nuh[i], are not used as reference for pictures with nuh_layer_id equal to layer_id_in_nuh[i]. enable_higher_layer_ref_pic_pred[i] equal to 1 specifies that within the CVS, the decoded pictures with nuh_layer_id greater than layer_id_in_nuh[i], when available, may be used as a reference for pictures with nuh_layer_id equal to layer_id_in_nuh[i] and temporal ID greater than 0. When not present, enable_higher_layer_ref_pic_pred[i] is inferred to be 0.

In this example, any higher layer may be a reference layer, and higher layer prediction is available for temporal layers whose temporal ID is greater than 0. Here, availability of the decoded pictures may be determined by whether there exist any decoded pictures in the same access unit as the current picture. For example, enable_higher_layer_ref_pic_pred[i] value of 1 indicates that higher layer decoded pictures, if there is any, may be used to code the current picture in the current layer. In another embodiment, the availability is not limited to the access unit of the current picture, but may include other temporally neighboring access units.

### Example Semantics #2

In another example, the following semantics may be used to define the flag or syntax element: enable_higher_layer_ref_pic_pred[i] equal to 0 specifies that within the CVS, the decoded pictures with nuh_layer_id greater than layer_id_in_nuh[i], are not used as reference for pictures with nuh_layer_id equal to layer_id_in_nuh[i]. enable_higher_layer_ref_pic_pred[i] equal to 1 specifies that within the CVS, the decoded pictures with nuh_layer_id greater than layer_id_in_nuh[i], when available, may be used as a reference for pictures with nuh_layer_id equal to layer_id_in_nuh[i]. When not present, enable_higher_layer_ref_pic_pred[i] is inferred to be equal to 0.

In this example, any higher layer may be a reference layer, and higher layer prediction is available for all temporal layers, not just for those layers whose temporal ID is greater than 0.

### Example Semantics #3

In yet another example, the following semantics may be used to define the flag or syntax element: enable_higher_layer_ref_pic_pred[i] equal to 0 specifies that within the CVS, the decoded pictures with nuh_layer_id greater than layer_id_in_nuh[i], are not used as reference for pictures with nuh_layer_id equal to layer_id_in_nuh[i]. enable_higher_layer_ref_pic_pred[i] equal to 1 specifies that within the CVS, the decoded pictures with nuh_layer_id equal to layer_id_in_nuh[i+1], when available, may be used as a reference for pictures with nuh_layer_id equal to layer_id_in_nuh[i] and temporal ID greater than 0. When not present, enable_higher_layer_ref_pic_pred[i] is inferred to be equal to 0.

In this example, an immediately higher layer may be a reference layer, and higher layer prediction is available for temporal layers whose temporal ID is greater than 0.

### Example Semantics #4

In yet another example, the following semantics may be used to define the flag or syntax element: enable_higher_layer_ref_pic_pred[i] equal to 0 specifies that within the CVS, the decoded pictures with nuh_layer_id greater than layer_id_in_nuh[i], are not used as reference for pictures with nuh_layer_id equal to layer_id_in_nuh[i]. enable_higher_layer_ref_pic_pred[i] equal to 1 specifies that within the CVS, the decoded pictures with nuh_layer_id equal to layer_id_in_nuh[i+1], when available, may be used as a reference for pictures with nuh_layer_id equal to layer_id_in_nuh[i]. When not present, enable_higher_layer_ref_pic_pred[i] is inferred to be equal to 0.

In this example, an immediately higher layer may be a reference layer, and higher layer prediction is available for all temporal layers, not just for those layers whose temporal ID is greater than 0.

### Location of the Flag or Syntax Element

The enable_higher_layer_ref_pic_pred[i] flag or syntax element discussed above may be signaled in VPS, SPS, PPS, slice header, and its extensions. It may also be signaled as a supplemental enhancement information (SEI) message or a video usability information (VUI) message.

### Example Flowchart

FIG. 4 is a flowchart illustrating a method 400 for coding video information, according to an embodiment of the present disclosure. The steps illustrated in FIG. 4 may be performed by an encoder (e.g., the video encoder as shown in FIG. 2A or FIG. 2B), a decoder (e.g., the video decoder as shown in FIG. 3A or FIG. 3B), or any other component. For convenience, method 400 is described as performed by a coder, which may be the encoder, the decoder, or another component.

The method 400 begins at block 401. In block 405, the coder determines whether higher layer decoded pictures are allowed to be used for coding current layer pictures. In block 410, the coder determines whether the current layer picture in the current layer has a corresponding higher layer picture in the higher layer. In block 415, the coder determines whether the temporal ID of the current layer picture is greater than 0. For example, restricting the usage of higher layer pictures to current layer pictures having a temporal ID greater than 0 ensures that there will be at least some key pictures in the current layer so that the adverse effects of drift is reduced. In response to determining that higher layer decoded pictures are allowed to be used for coding current layer pictures, that the current layer picture in the current layer has a corresponding higher layer picture in the higher layer, and that the temporal ID of the current layer picture is greater than 0, the coder codes the current layer picture based on the corresponding higher layer picture. The method 400 ends at 425.

As discussed above, one or more components of video encoder 20 of FIG. 2A, video encoder 23 of FIG. 2B, video decoder 30 of FIG. 3A, or video decoder 33 of FIG. 3B (e.g., inter-layer prediction unit 128 and/or inter-layer prediction unit 166) may be used to implement any of the techniques discussed in the present disclosure, such as determining whether higher layer decoded pictures are allowed to be used for coding current layer pictures, determining whether the current picture in the current layer has a corresponding higher layer picture in the higher layer, determining whether the temporal ID of the current picture is greater than 0, and coding the current picture based on the corresponding higher layer picture.

In the method 400, one or more of the blocks shown in FIG. 4 may be removed (e.g., not performed) and/or the order in which the method is performed may be switched. For example, although block 415 is shown in FIG. 4, it may be removed to remove the restriction that the temporal ID of the current layer picture be greater than 0. As another example, although block 420 is shown in FIG. 4, actually coding the current layer picture need not be part of the method 400 and thus omitted from the method 400. Thus, the embodiments of the present disclosure are not limited to or by the example shown in FIG. 4, and other variations may be implemented without departing from the spirit of this disclosure.

### No Explicit Signaling of Usage of Higher Layer Decoded Pictures

In this embodiment, for each picture, whether the picture uses a higher layer reference picture is determined using the process described below.

To determine whether the current picture may use a higher layer decoded picture for prediction, an example variable enableHigherLayerRefpicforCurrPicFlag is introduced. The variable enableHigherLayerRefpicforCurrPicFlag for the current picture in the current layer having a layer index equal to i may be defined as follows: enableHigherLayerRefpicforCurrPicFlag equal to 0 specifies that for the current picture with nuh_layer_id equal to layer_id_in_nuh[i], the decoded pictures with nuh_layer_id greater than layer_id_in_nuh[i], are not used as reference for current picture. enableHigherLayerRefpicforCurrPicFlag equal to 1 specifies that for the current picture with nuh_layer_id equal to layer_id_in_nuh[i], the decoded pictures with nuh_layer_id equal to layer_id_in_nuh[i+1], when available, may be used as a reference for current picture.

For the current picture in the current layer having a layer index of i, the value of the variable enableHigherLayerRefpicforCurrPicFlag is set to 1 if all of the following conditions are met:

a) temporal ID of the current picture is equal to 0;

b) scalability_mask [i] is equal to 1, indicating SNR or spatial scalability;

c) the VPS flag enable_higher_layer_ref_pic_pred[i] (e.g., discussed above) is equal to 1, indicating that higher layer prediction is allowed; and

d) the corresponding decoded pictures with nuh_layer_id equal to layer_id_in_nuh[i+1] is available (e.g., collocated picture corresponding to the current picture is present in the same access unit).

If all of these conditions are met, the variable enableHigherLayerRefpicforCurrPicFlag is set to 1 to indicate that higher layer decoded pictures may be used to code the current picture. If one or more of these conditions are not satisfied, the variable enableHigherLayerRefpicforCurrPicFlag is set to zero to indicate that higher layer decoded pictures may not be used to code the current picture.

### Explicit Signaling of Usage of Higher Layer Decoded Pictures

In an alternative embodiment, a flag, enableHigherLayerRefpicforCurrPicFlag, may be explicitly signaled to specify whether the current picture in the current layer uses higher layer reference pictures as a reference. The enableHigherLayerRefpicforCurrPicFlag flag may be defined as follows: enableHigherLayerRefpicforCurrPicFlag equal to 0 specifies that for the current picture with nuh_layer_id equal to layer_id_in_nuh[i], the decoded pictures with nuh_layer_id greater than layer_id_in_nuh[i], are not used as reference for current picture. enableHigherLayerRefpicforCurrPicFlag equal to 1 specifies that for the current picture with nuh_layer_id equal to layer_id_in_nuh[i], the decoded pictures with nuh_layer_id equal to layer_id_in_nuh[i+1], when available, is used as a reference for current picture. For example, the enableHigherLayerRefpicforCurrPicFlag flag may be signaled in the PPS, slice header, or its extensions. It may also be signaled as an SEI message or a VUI message.

In another embodiment, a flag, enableHigherLayerRefpicforCurrPicFlag, is explicitly signaled to specify whether the current picture in the current layer uses higher layer reference pictures as a reference. The enableHigherLayerRefpicforCurrPicFlag flag may be defined as follows: enableHigherLayerRefpicforCurrPicFlag equal to 0 specifies that for the current picture with nuh_layer_id equal to layer_id_in_nuh[i], the decoded pictures with nuh_layer_id greater than layer_id_in_nuh[i], are not used as reference for current picture. enableHigherLayerRefpicforCurrPicFlag equal to 1 specifies that for the current picture with nuh_layer_id equal to layer_id_in_nuh[i], the decoded pictures with nuh_layer_id equal to layer_id_in_nuh[i+k], when available, is used as a reference for current picture.

In this embodiment, instead of using reference pictures of higher layer that is immediately above the current layer (e.g., layer_id_in_nuh[i+1] as shown in the previous example), reference pictures of the k-th higher layer above the current layer are used to code the current picture (e.g., layer_id_in_nuh[i+k] as shown in this example). For example, the value of k may be explicitly signaled or inferred from direct dependency flag signaled in VPS.

### Interpretation of Flag Indicating Usage of Higher Layer Reference Picture

In one embodiment, the value of enableHigherLayerRefpicforCurrPicFlag has the same value for all pictures of the same layer within the same CVS having a temporal ID greater than 0. Such a restriction may be implemented as a bitstream conformance constraint such that any conforming bitstream would meet such a restriction.

In another embodiment, the value of enableHigherLayerRefpicforCurrPicFlag has the same value for all pictures of the same layer within the same CVS having a temporal ID equal to 0. Such a restriction may be implemented as a bitstream conformance constraint such that any conforming bitstream would meet such a restriction.

### Example Implementation of Derivation Process for RPS and Picture Marking

In one embodiment, the derivation process for the RPS and picture marking may be implemented as illustrated below. Any changes with respect to an example coding scheme (e.g., HEVC) are highlighted in italics and deletions are indicated by strikethrough. Section F.8.1.3 of a draft specification of HEVC scalable extension, which is referenced in the example implementation, is also reproduced below.

Section F.8.1.3 Generation of Unavailable Reference Pictures for Pictures First in Decoding Order within a Layer
This process is invoked for a picture with nuh_layer_id equal to layerId, when FirstPicInLayerDecodedFlag[layerId] is equal to 0.
NOTE—A cross-layer random access skipped (CL-RAS) picture is a picture with nuh_layer_id equal to layerId such that LayerInitialisedFlag[layerId] is equal to 0 when the decoding process for starting the decoding of a coded picture with nuh_layer_id greater than 0 is invoked. The entire specification of the decoding process for CL-RAS pictures is included only for purposes of specifying constraints on the allowed syntax content of such CL-RAS pictures. During the decoding process, any CL-RAS pictures may be ignored, as these pictures are not specified for output and have no effect on the decoding process of any other pictures that are specified for output. However, in HRD operations as specified in Annex C, CL-RAS pictures may need to be taken into consideration in derivation of CPB arrival and removal times.
   When this process is invoked, the following applies:
For each RefPicSetStCurrBefore[i], with i in the range of 0 to NumPocStCurrBefore−1, inclusive, that is equal to “no-reference picture”, a picture is generated as specified in subclause 8.3.3.2, and the following applies:
   The value of PicOrderCntVal for the generated picture is set equal to PocStCurrBefore[i].
   The value of PicOutputFlag for the generated picture is set equal to 0.
   The generated picture is marked as “used for short-term reference”.
   RefPicSetStCurrBefore[i] is set to be the generated reference picture.
   The value of nuh_layer_id for the generated picture is set equal to nuh_layer_id.
For each RefPicSetStCurrAfter[i], with i in the range of 0 to NumPocStCurrAfter−1, inclusive, that is equal to “no-reference picture”, a picture is generated as specified in subclause 8.3.3.2, and the following applies:
   The value of PicOrderCntVal for the generated picture is set equal to PocStCurrAfter[i].
   The value of PicOutputFlag for the generated picture is set equal to 0.
   The generated picture is marked as “used for short-term reference”.
   RefPicSetStCurrAfter[i] is set to be the generated reference picture.
   The value of nuh_layer_id for the generated picture is set equal to nuh_layer_id.
For each RefPicSetStFoll[i], with i in the range of 0 to NumPocStFoll−1, inclusive, that is equal to “no reference picture”, a picture is generated as specified in subclause 8.3.3.2, and the following applies:
   The value of PicOrderCntVal for the generated picture is set equal to PocStFoll[i].
   The value of PicOutputFlag for the generated picture is set equal to 0.
   The generated picture is marked as “used for short-term reference”.
   RefPicSetStFoll[i] is set to be the generated reference picture.
   The value of nuh_layer_id for the generated picture is set equal to nuh_layer_id.
For each RefPicSetLtCurr[i], with i in the range of 0 to NumPocLtCurr−1, inclusive, that is equal to “no-reference picture”, a picture is generated as specified in subclause 8.3.3.2, and the following applies:
   The value of PicOrderCntVal for the generated picture is set equal to PocLtCurr[i].
   The value of slice_pic_order_cnt_lsb for the generated picture is inferred to be equal to (PocLtCurr[i] & (MaxPicOrderCntLsb−1)).
   The value of PicOutputFlag for the generated picture is set equal to 0.
   The generated picture is marked as “used for long-term reference”.
   RefPicSetLtCurr[i] is set to be the generated reference picture.
   The value of nuh_layer_id for the generated picture is set equal to nuh_layer_id.
For each RefPicSetLtFoll[i], with i in the range of 0 to NumPocLtFoll−1, inclusive, that is equal to “no reference picture”, a picture is generated as specified in subclause 8.3.3.2, and the following applies:
   The value of PicOrderCntVal for the generated picture is set equal to PocLtFoll[i].
   The value of slice_pic_order_cnt_lsb for the generated picture is inferred to be equal to (PocLtFoll[i] & (MaxPicOrderCntLsb−1)).
   The value of PicOutputFlag for the generated picture is set equal to 0.
   The generated picture is marked as “used for long-term reference”.
   RefPicSetLtFoll[i] is set to be the generated reference picture.
   The value of nuh_layer_id for the generated picture is set equal to nuh_layer_id.

### Section F.8.3.2 Decoding Process for Reference Picture Set

The derivation process for the RPS and picture marking are performed according to the following ordered steps:
1. The following applies:

for( i = 0; i < NumPocLtCurr; i++ )

if( !CurrDeltaPocMsbPresentFlag[ i ] )

if( there is a reference picture picX in the DPB with slice_pic_order_cnt_lsb equal

to PocLtCurr[ i ] and nuh_layer_id equal to currPicLayerId + offsetPicLayerId, which
is derived by invoking the subclause F.8.1.3 with slice_{—}pic_{—}order_{—}cnt_{—}lsb, PocLtCurr[ i ]
given as inputs)

RefPicSetLtCurr[ i ] = picX

else

RefPicSetLtCurr[ i ] = “no reference picture”

else

if( there is a reference picture picX in the DPB with PicOrderCntVal equal to

PocLtCurr[ i ] and nuh_layer_id equal to currPicLayerId + offsetPicLayerId, which is
derived by invoking the subclause F.8.1.3 with PicOrderCntVal, PocLtCurr[ i ] given as
inputs)

RefPicSetLtCurr[ i ] = picX

else

RefPicSetLtCurr[ i ] = “no reference picture”

(F-3)

for( i = 0; i < NumPocLtFoll; i++ )

if( !FollDeltaPocMsbPresentFlag[ i ] )

if( there is a reference picture picX in the DPB with slice_pic_order_cnt_lsb equal

to PocLtFoll[ i ] and nuh_layer_id equal to currPicLayerId + offsetPicLayerId, which is
derived by invoking the subclause F.8.1.3 with slice_{—}pic_{—}order_{—}cnt_{—}lsb, PocLtFoll [ i ]
given as inputs)

RefPicSetLtFoll[ i ] = picX

else

RefPicSetLtFoll[ i ] = “no reference picture”

else

if( there is a reference picture picX in the DPB with PicOrderCntVal equal to

PocLtFoll[ i ] and nuh_layer_id equal to currPicLayerId + offsetPicLayerId, which is
derived by invoking the subclause F.8.1.3 with PicOrderCntVal, PocLtFoll [ i ] given as
inputs)

RefPicSetLtFoll[ i ] = picX

else

RefPicSetLtFoll[ i ] = “no reference picture”

2. All reference pictures that are included in RefPicSetLtCurr and RefPicSetLtFoll and with nuh_layer_id equal to currPicLayerId are marked as “used for long-term reference”.
3. The following applies:

for( i = 0; i < NumPocStCurrBefore; i++ )

if( there is a short-term reference picture picX in the DPB

with PicOrderCntVal equal to PocStCurrBefore[ i ] and nuh_layer_id equal to

currPicLayerId + offsetPicLayerId, which is derived by invoking the
subclause F.8.1.3 with PicOrderCntVal, PocStCurrBefore [ i ] given as inputs)

RefPicSetStCurrBefore[ i ] = picX

else

RefPicSetStCurrBefore[ i ] = “no reference picture”

for( i = 0; i < NumPocStCurrAfter; i++ )

if( there is a short-term reference picture picX in the DPB

with PicOrderCntVal equal to PocStCurrAfter[ i ] and nuh_layer_id equal to

currPicLayerId + offsetPicLayerId, which is derived by invoking the
subclause F.8.1.3 with PicOrderCntVal, PocStCurr After [ i ] given as inputs)

RefPicSetStCurrAfter[ i ] = picX

else

RefPicSetStCurrAfter[ i ] = “no reference picture”

for( i = 0; i < NumPocStFoll; i++ )

if( there is a short-term reference picture picX in the DPB

with PicOrderCntVal equal to PocStFoll[ i ] and nuh_layer_id equal to

currPicLayerId + offsetPicLayerId, which is derived by invoking the
subclause F.8.1.3 with PicOrderCntVal, PocStFoll [ i ] given as inputs)

RefPicSetStFoll[ i ] = picX

else

RefPicSetStFoll[ i ] = “no reference picture”

4. All reference pictures in the DPB that are not included in RefPicSetLtCurr, RefPicSetLtFoll, RefPicSetStCurrBefore, RefPicSetStCurrAfter, or RefPicSetStFoll and with nuh_layer_id equal to currPicLayerId are marked as “unused for reference”.
Derivation Process of offsetPicLayerId
The derivation of the offsetPicLayerId variable introduced above may be performed as follows:

Inputs to this process are
- Variable currPocVal corresponding to PicOrderCntVal for short-term reference pictures
and slice_{—}pic_{—}order_{—}cnt_{—}lsb for long-term reference pictures.
- Variable refPocVal corresponding to the poc values of five lists PocStCurrBefore,
PocStCurrAfter, PocStFoll, PocLtCurr, and PocLtFoll.
Output to this process are
- offsetPicLayerId corresponding to picture with nuh_{—}layer_{—}id equal to currPicLayerId
Let Variable currPicTemporalId is set to be the TemporalId of the current picture
The variable CurrPicnoResampleFlag is be set equal to to
enable_{—}non_{—}curr_{—}layer_{—}ref_{—}pic_{—}pred[ currPicLayerId ]
if( there is a reference picture picX in the DPB with currPocVal equal to
refPocVal and nuh_{—}layer_{—}id equal to currPicLayerId + 1, and CurrPicnoResampleFlag is
equal to 1 and currPicTemporalId is greater than 0)

offsetPicLayerId = 1

else

offsetPicLayerId = 0

Section F.13.5.2.2 Output and Removal of Pictures from the DPB
The output and removal of pictures from the DPB before the decoding of the current picture (but after parsing the slice header of the first slice of the current picture) happens instantaneously when the first decoding unit of the current picture is removed from the CPB and proceeds as follows:
The decoding process for RPS as specified in subclause F.8.3.2 is invoked to mark only the pictures with the same value of nuh_layer_id.

### Temporal Motion Vectors Update for Higher Layer Pictures

Various embodiments described above may use temporal motion vector predictor (TMVP) candidate of enhancement layer for reference layer along with samples. Although doing so may improve coding efficiency, it may at the same time cause drift during motion vector decoding when EL packets are not present in the bitstream (e.g., if they are missing or intentionally abandoned).

Described below are some example embodiments that may help overcome this drift. These example embodiments can be applied independently from each other or in combination, and may be applicable or extended to scalable coding, multi-view coding with or without depth, and other extensions to HEVC and other video codecs.

### Key Access Unit

The term “key access unit” may refer to an access unit that contains only key pictures. A key picture may be a picture having a temporal ID of 0. In another example, a key picture may be a picture that is explicitly signaled as a key picture. The term “non-key access unit” may refer to an access unit that is not a key access unit.

### TMVP Update for Higher Layer Picture

When higher layer pictures are used as reference for lower layers then following temporal motion vector information update for higher layers is proposed . . . .

In one embodiment, after decoding the last decoding unit of a non-key access unit, for all layers starting from layer index i>0, the temporal motion vector information is copied from the collocated reference picture in a lower layer with index j=i−1, if such a lower layer exists, to its immediately higher layer with layer index i. For a key access unit, such an update is omitted.

In another embodiment, after decoding the last decoding unit of a non-key access unit, for all layers starting from layer index i>0, the temporal motion vector information is copied from the collocated reference picture in a lower layer with index j=i−1, if such a lower layer exists, to its immediately higher layer with layer index i. In this example, the layer index j may be explicitly signaled. For example, if there are more than one enhancement layer from which the current layer derive information (e.g., temporal motion vector information), the layer index j of the enhancement layer used for the current can be signaled in the bitstream.

In yet another example, a flag may optionally be signaled to explicitly enable or disable the processes defined in above paragraphs. This flag may be signaled at different granularity syntax parameter sets such as VPS, SPS, PPS, or as a VUI or SEI message, and in slice header or at their respective extension headers.

Single-Loop Decoding Mechanism with Key Picture Framework

It is possible and sometimes desirable to use single-loop decoding structure in certain implementations (e.g., SHVC) if the inter-layer texture prediction is restricted to collocated coding units (CUs) that are coded using constrained intra prediction (CIP) or collocated CUs that are coded without reference to any information from earlier access units in the decoding order. In one example, coding a CU without reference to any information from earlier access units in the decoding order may mean that the CU is coded using inter-layer texture prediction (e.g., Intra BL).

However, in existing coding schemes, this indication of whether single-loop decoding structure is enabled may not be available. By using the example embodiments described below, single-loop decoding can be utilized more advantageously.

### Single-Loop Decoding: Key Access Units

In this embodiment, when higher layer reference pictures are used as reference for lower layers, an encoder conformance restriction is implemented, which states that for key access units, inter-layer prediction is performed only using the residual data and decoded samples of neighboring coding blocks that are predicted from the samples coded with no information directly or indirectly from earlier access units in decoding order. Such a restriction may be signaled using a flag. An example flag key_pic_constrained_inter_layer_pred_idc may be defined as follows: key_pic_constrained_inter_layer_pred_idc equal to 0 indicates that for key access units (or pictures), inter-layer prediction uses residual data and decoded samples of collocated coding units that are coded using either intra or inter prediction modes. constrained_inter_layer_pred_flag equal to 1 indicates constrained inter-layer prediction, in which case inter-layer prediction only uses residual data and decoded samples from collocated coding units that are coded with no information directly or indirectly from earlier access units in decoding order, through infra/inter prediction or inter-layer prediction or their combination.

The flag may be signaled at different granularity syntax parameter sets such as VPS, SPS, PPS, or as a VUI or SEI message, and in slice header or at their respective extension headers.

### Single-Loop Decoding: Non-Key Access Units

For non-key access units (or pictures), in order to allow single-loop decoding, the following restrictions may be applied:

1) disable the de-blocking filter and sample adaptive offset (SAO) for the reference layer pictures;

2) enable constrained intra prediction (CIP) for the reference layer pictures

3) disable non-zero motion prediction from reconstructed reference layer pictures; and

4) disable bi-prediction for an enhancement layer block when only one of the reference picture index refldxLX (X being replaced by either 0 or 1) of each sample in the current block corresponds to a reference layer picture and the collocated reference sample for the current layer sample uses bi-prediction.

Alternatively, the fourth restriction may be replaced by the following:

4) disable bi-prediction for an enhancement layer block when only one of the reference picture index refldxLX (X being replaced by either 0 or 1) corresponding to the current layer samples (xCurr, yCurr) points to a reference layer picture and the collocated reference sample uses bi-prediction.

In this example, if all four of the above restrictions are satisfied, single-loop decoding may be enabled for non-key access units. For example, in single-loop decoding, the EL may be decoded without fully reconstructing the reference layer for non-key access units. Single-loop decoding is enabled in this example because the BL and the EL both use the same references for inter prediction. In this example, the EL may add another residual signal to the reconstruction. For example, the encoder may add additional error signals to the bitstream. Such additional error signals may be used to improve the quality of the decoded pictures and improve the video quality.

### Usage of Different Representation of Higher Layer Picture

In one embodiment, whether a different representation (e.g., resampling) of higher layer pictures may be used is inferred using the below derivation process. For example, before using a higher layer reference picture to code the current picture, the higher layer reference picture may need to be converted into a different representation (e.g., size, bit-depth, etc.).

In one example, an example variable additionalHigherLayerRefpicforCurrPicFlag may be used. The variable additionalHigherLayerRefpicforCurrPicFlag for the current picture in the current layer having a layer id i may be defined as follows: additionalHigherLayerRefpicforCurrPicFlag equal to 0 specifies that for the current picture with nuh_layer_id equal to layer_id_in_nuh[i], when the the decoded pictures with nuh_layer_id greater than layer_id_in_nuh[i], are used as reference for current picture, no additional reference picture representation is needed. additionalHigherLayerRefpicforCurrPicFlag equal to 1 specifies that for the current picture with nuh_layer_id equal to layer_id_in_nuh[i], when the the decoded pictures with nuh_layer_id greater than layer_id_in_nuh[i], are used as reference for current picture, additional reference picture representation is needed.

In one embodiment, for a current picture in the current layer having a layer ID i, the value of additionalHigherLayerRefpicforCurrPicFlag may be set to 0 for SNR scalability, and 1 for other scalability.

In another embodiment, variables PicWidthInSamplesL and PicHeightlnSamplesL may be set equal to the width and height of current picture in units of luma samples, respectively, and variables RefLayerPicWidthInSamplesL and RefLayerPicHeightlnSamplesL may be set equal to the width and height of the decoded reference layer picture in units of luma samples, respectively. In addition, variables ScaledRefLayerLeftOffset, ScaledRefLayerTopOffset, ScaledRefLayerRightOffset and ScaledRefLayerBottomOffset may be derived as follows:

ScaledRefLayerLeftOffset = scaled_ref_layer_left_offset[
dRlIdx ] << 1
ScaledRefLayerTopOffset = scaled_ref_layer_top_offset[
dRlIdx] << 1
ScaledRefLayerRightOffset = scaled_ref_layer_right_offset[
dRlIdx ] << 1
ScaledRefLayerBottomOffset = scaled_ref_layer_bottom_offset[
dRlIdx ] << 1

When PicWidthlnSamplesL of the current layer is equal to RefLayerPicWidthlnSamplesL, and PicHeightlnSamplesL of the current layer is equal to RefLayerPicHeightInSamplesL, and the values of ScaledRefLayerLeftOffset, ScaledRefLayerTopOffset, ScaledRefLayerRightOffset, and ScaledRefLayerBottomOffset are all equal to 0, the value of additionalHigherLayerRefpicforCurrPicFlag may be set to 0. Otherwise, the value of additionalHigherLayerRefpicforCurrPicFlag is set to 1.

In another embodiment, when max_num_ref_frames (e.g., indicating the number of reference pictures used), which may be in the sequence parameter set (SPS) referred to by the associated NAL unit, is less than 2, additionalHigherLayerRefpicforCurrPicFlag may be set to 0. A bitstream conformance restriction stating that after marking the current decoded reference picture and, when additionalHigherLayerRefpicforCurrPicFlag is equal to 1, the current reference base picture, the total number of frames marked as “used for reference” is not to exceed the greater of max_num_ref_frames and 1. Reference pictures that have additionalHigherLayerRefpicforCurrPicFlag equal to 1 are only used as reference pictures for inter prediction and are not output.

Coding Efficiency Vs. Drift Revisited

As discussed above, there may be a trade-off between coding efficiency and drift effects. Various embodiments for allowing coding of lower layer pictures based on higher layer pictures and at the same time minimizing the effects of drift have been discussed in the present disclosure. In one or more of such embodiments, both motion and texture information may be derived from higher layer decoded picture.

Motion Information and Texture Information from Different Layers

In another embodiment, motion information may be derived from temporal pictures of the current layer, and texture information may be derived from higher layer decoded pictures for coding the current picture in the current layer. It may be understood that texture information from a higher layer may have better quality. However, there may be instances when it might be better to derive the motion information from the current layer. Additionally, when higher layer packets are lost, the error introduced (e.g., drift) in the motion information may be more severe than the error introduced in the texture information. Thus, by deriving the motion information from the current layer, at least the motion information may be made drift-proof in case higher layer packets are lost or intentionally abandoned.

Described below are some example implementations for using the motion information derived from the current layer and the texture information derived from a higher layer when coding a current picture in the current layer. These methods can be applied independently from each other or in combination, and may be applicable or extended to scalable coding, multi-view coding with or without depth, and other extensions to HEVC and other video codecs.

### Embodiment #1

### High Level Modification

In one embodiment, reference picture set (RPS) construction is modified such that the RPS contains pictures from both EL and BL. For example, the number of entries in the RPS is doubled, where the number of EL pictures in the RPS is equal to the number of BL pictures in the RPS. In one embodiment, the RPS may be modified as shown in section F.8.3.2 below. In another embodiment, the RPS may be modified to include additional BL pictures using any method not discussed herein, including any method known in the art.

After the RPS is constructed, a reference picture list (RPL) is constructed. In one example, the RPS may contain all decoded picture that may be used to code the current picture, whereas the RPL may contain those decoded pictures that are likely to be used by the current picture. The encoder may choose which pictures are inserted into the RPL. Each of the reference pictures in the RPL may be referenced using a corresponding reference index.

After the RPL is constructed, the RPL is modified. In one embodiment, the RPL is modified as shown in section H.8.3.4 below (e.g., by replacing the last entry in the RPL that has a collocated reference index with a corresponding base layer picture that is present in the RPS). For example, the encoder may determine that it may be desirable to insert BL Picture #1 into the RPL of the current picture in the base layer. In such a case, the encoder may replace the last picture in the RPL with BL Picture #1. In another embodiment, BL Picture #1 replaces the EL reference picture corresponding to BL Picture #1 (e.g., in the same access unit) in the RPL. In another embodiment, BL Picture #1 may replace any EL picture at any position in the RPL of the current picture.

### Implementation of Embodiment #1: Proposed Modification to SHVC Specification

The following changes (shown in italics) may be made to the draft of HEVC scalable extension (SHVC).

### Section F.8.3.2 Decoding Process for Reference Picture Set

The RPS of the current picture consists of five RPS lists; RefPicSetStCurrBefore, RefPicSetStCurrAfter, RefPicSetStFoll, RefPicSetLtCurr and RefPicSetLtFoll. RefPicSetStCurrBefore, RefPicSetStCurrAfter, and RefPicSetStFoll are collectively referred to as the short-term RPS. RefPicSetLtCurr and RefPicSetLtFoll are collectively referred to as the long-term RPS.
NOTE 1—RefPicSetStCurrBefore, RefPicSetStCurrAfter, and RefPicSetLtCurr contain all reference pictures that may be used for inter prediction of the current picture and one or more pictures that follow the current picture in decoding order. RefPicSetStFoll and RefPicSetLtFoll consist of all reference pictures that are not used for inter prediction of the current picture but may be used in inter prediction for one or more pictures that follow the current picture in decoding order.
   The variable offsetPicLayerId is set equal to 1 when enable_higher_layer_ref_pic_pred[currPicLayerId] not equal to 0 and TemporalId is not equal to 0 for the current picture.
   The derivation process for the RPS and picture marking are performed according to the following ordered steps:
1. The following applies:

for( i = 0; i < NumPocLtCurr; i++ )

if( !CurrDeltaPocMsbPresentFlag[ i ] )

if( there is a reference picture picX in the DPB with slice_pic_order_cnt_lsb equal

to PocLtCurr[ i ] and nuh_layer_id equal to currPicLayerId + offsetPicLayerId)

RefPicSetLtCurr[ i ] = picX

else

RefPicSetLtCurr[ i ] = “no reference picture”

else

if( there is a reference picture picX in the DPB with PicOrderCntVal equal to

PocLtCurr[ i ] and nuh_layer_id equal to currPicLayerId + offsetPicLayerId )

RefPicSetLtCurr[ i ] = picX

else

RefPicSetLtCurr[ i ] = “no reference picture”

for( i = 0; i < NumPocLtFoll; i++ )

if( !FollDeltaPocMsbPresentFlag[ i ] )

if( there is a reference picture picX in the DPB with slice_pic_order_cnt_lsb equal

to PocLtFoll[ i ] and nuh_layer_id equal to currPicLayerId + offsetPicLayerId )

RefPicSetLtFoll[ i ] = picX

else

RefPicSetLtFoll[ i ] = “no reference picture”

else

if( there is a reference picture picX in the DPB with PicOrderCntVal equal to

PocLtFoll[ i ] and nuh_layer_id equal to currPicLayerId + offsetPicLayerId )

RefPicSetLtFoll[ i ] = picX

else

RefPicSetLtFoll[ i ] = “no reference picture”

if(offsetLayerId) {

for( i = 0; i < NumPocLtCurr; i++ )

if( !CurrDeltaPocMsbPresentFlag[ i ] )

if( there is a reference picture picX in the DPB with slice_{—}pic_{—}order_{—}cnt_{—}lsb

equal to PocLtCurr[ i ] and nuh_{—}layer_{—}id equal to currPicLayerId)

RefPicSetLtCurr[ i + NumPocLtCurr] = picX

else

RefPicSetLtCurr[ i + NumPocLtCurr] = “no reference picture”

else

if( there is a reference picture picX in the DPB with PicOrderCntVal equal to

PocLtCurr[ i ] and nuh_{—}layer_{—}id equal to currPicLayerId)

RefPicSetLtCurr[ i + NumPocLtCurr] = picX

else

RefPicSetLtCurr[ i + NumPocLtCurr] = “no reference picture”

for( i = 0; i < NumPocLtFoll; i++ )

if( !FollDeltaPocMsbPresentFlag[ i ] )

if( there is a reference picture picX in the DPB with slice_{—}pic_{—}order_{—}cnt_{—}lsb

equal to PocLtFoll[ i ] and nuh_{—}layer_{—}id equal to currPicLayerId)

RefPicSetLtFoll[ i + NumPocLtFoll] = picX

else

RefPicSetLtFoll[ i + NumPocLtFoll] = “no reference picture”

else

if( there is a reference picture picX in the DPB with PicOrderCntVal equal to

PocLtFoll[ i ] and nuh_{—}layer_{—}id equal to currPicLayerId)

RefPicSetLtFoll[ i + NumPocLtFoll] = picX

else

RefPicSetLtFoll[ i + NumPocLtFoll] = “no reference picture”

}

2. All reference pictures that are included in RefPicSetLtCurr and RefPicSetLtFoll and with nuh_layer_id equal to currPicLayerId are marked as “used for long-term reference”.
3. The following applies:

for( i = 0; i < NumPocStCurrBefore; i++ )

if( there is a short-term reference picture picX in the DPB

with PicOrderCntVal equal to PocStCurrBefore[ i ] and nuh_layer_id equal to

currPicLayerId + offsetPicLayerId)

RefPicSetStCurrBefore[ i ] = picX

else

RefPicSetStCurrBefore[ i ] = “no reference picture”

for( i = 0; i < NumPocStCurrAfter; i++ )

if( there is a short-term reference picture picX in the DPB

with PicOrderCntVal equal to PocStCurrAfter[ i ] and nuh_layer_id equal to

currPicLayerId + offsetPicLayerId)

RefPicSetStCurrAfter[ i ] = picX

else

RefPicSetStCurrAfter[ i ] = “no reference picture”

for( i = 0; i < NumPocStFoll; i++ )

if( there is a short-term reference picture picX in the DPB

with PicOrderCntVal equal to PocStFoll[ i ] and nuh_layer_id equal to

currPicLayerId + offsetPicLayerId)

RefPicSetStFoll[ i ] = picX

else

RefPicSetStFoll[ i ] = “no reference picture”

if(offsetPicLayerId){
for( i = 0; i < NumPocStCurrBefore; i++ )

if( there is a short-term reference picture picX in the DPB

with PicOrderCntVal equal to PocStCurrBefore[ i ] and nuh_{—}layer_{—}id equal

to currPicLayerId)

RefPicSetStCurrBefore[ i + NumPocStCurrBefore] = picX

else

RefPicSetStCurrBefore[ i + NumPocStCurrBefore] = “no reference picture”

for( i = 0; i < NumPocStCurrAfter; i++ )

if( there is a short-term reference picture picX in the DPB

with PicOrderCntVal equal to PocStCurr After[ i ] and nuh_{—}layer_{—}id equal to

currPicLayerId)

RefPicSetStCurrAfter[ i + NumPocStCurrBefore] = picX

else

RefPicSetStCurrAfter[ i + NumPocStCurrBefore] = “no reference picture”

for( i = 0; i < NumPocStFoll; i++ )

if( there is a short-term reference picture picX in the DPB

with PicOrderCntVal equal to PocStFoll[ i ] and nuh_{—}layer_{—}id equal to

currPicLayerId)

RefPicSetStFoll[ i + NumPocStCurrBefore] = picX

else

RefPicSetStFoll[ i + NumPocStCurrBefore] = “no reference picture”

}

4. All reference pictures in the DPB that are not included in RefPicSetLtCurr, RefPicSetLtFoll, RefPicSetStCurrBefore, RefPicSetStCurrAfter, or RefPicSetStFoll and with nuh_layer_id equal to currPicLayerId are marked as “unused for reference”.
NOTE 2—There may be one or more entries in the RPS lists that are equal to “no reference picture” because the corresponding pictures are not present in the DPB. Entries in RefPicSetStFoll or RefPicSetLtFoll that are equal to “no reference picture” should be ignored. An unintentional picture loss should be inferred for each entry in RefPicSetStCurrBefore, RefPicSetStCurrAfter, or RefPicSetLtCurr that is equal to “no reference picture”.
   Section F.13.5.2.2 Output and Removal of Pictures from the DPB
   The output and removal of pictures from the DPB before the decoding of the current picture (but after parsing the slice header of the first slice of the current picture) happens instantaneously when the first decoding unit of the current picture is removed from the CPB and proceeds as follows:
The decoding process for RPS as specified in subclause F.8.3.2 is invoked to mark only the pictures with the same value of nuh_layer_id.

### Section H.8.3.4 Decoding Process for Reference Picture Lists Construction

This process is invoked at the beginning of the decoding process for each P or B slice.
Reference pictures are addressed through reference indices as specified in subclause 8.5.3.3.2. A reference index is an index into a reference picture list. When decoding a P slice, there is a single reference picture list RefPicList0. When decoding a B slice, there is a second independent reference picture list RefPicList1 in addition to RefPicList0.
At the beginning of the decoding process for each slice, the reference picture lists RefPicList0 and, for B slices, RefPicList1 are derived as follows:
The variable offsetPicLayerId is set equal to 1 when enable_higher_layer_ref_pic_pred[currPicLayerId] is equal to 1 and TemporalId is greater than 0 for the current picture
The variable NumRpsCurrTempList0 is set equal to Max(num_ref_idx_{—}10_active_minus1+1, NumPicTotalCurr) and the list RefPicListTemp0 is constructed as follows:

rIdx = 0
while( rIdx < NumRpsCurrTempList0 ) {

for( i = 0; i < NumPocStCurrBefore && rIdx < NumRpsCurrTempList0; rIdx++, i++ )

RefPicListTemp0[ rIdx ] = RefPicSetStCurrBefore[ i ]

for( i = 0; i < NumActiveRefLayerPics0; rIdx++, i++ )

RefPicListTemp0[ rIdx ] = RefPicSetInterLayer0[ i ]

for( i = 0; i < NumPocStCurrAfter && rIdx < NumRpsCurrTempList0; rIdx++, i++ )

RefPicListTemp0[ rIdx ] = RefPicSetStCurrAfter[ i ]

for( i = 0; i < NumPocLtCurr && rIdx < NumRpsCurrTempList0; rIdx++, i++ )

RefPicListTemp0[ rIdx ] = RefPicSetLtCurr[ i ]

for( i = 0; i < NumActiveRefLayerPics1; rIdx++, i++ )

RefPicListTemp0[ rIdx ] = RefPicSetInterLayer1[ i ]

}
while( rIdx < NumRpsCurrTempList0 << offsetPicLayerId) {

for( i = 0; i < NumPocStCurrBefore && rIdx < NumRpsCurrTempList0; rIdx++, i++

)

RefPicListTemp0[ rIdx ] = RefPicSetStCurrBefore[ i + NumRpsCurrTempList0]

for( i = 0; i < NumActiveRefLayerPics0; rIdx++, i++ )

RefPicListTemp0[ rIdx ] = RefPicSetInterLayer0[ i + NumRpsCurrTempList0]

for( i = 0; i < NumPocStCurrAfter && rIdx < NumRpsCurrTempList0; rIdx++, i++ )

RefPicListTemp0[ rIdx ] = RefPicSetStCurrAfter[ i + NumRpsCurrTempList0]

for( i = 0; i < NumPocLtCurr && rIdx < NumRpsCurrTempList0; rIdx++, i++ )

RefPicListTemp0[ rIdx ] = RefPicSetLtCurr[ i + NumRpsCurrTempList0]

for( i = 0; i < NumActiveRefLayerPics1; rIdx++, i++ )

RefPicListTemp0[ rIdx ] = RefPicSetInterLayer1[ i + NumRpsCurrTempList0]

}

The list RefPicList0 is constructed as follows:

for ( rIdx = 0; rIdx <= num_ref_idx_l0_active_minus1; rIdx++)

RefPicList0[ rIdx ] = ref_pic_list_modification_flag_l0 ?

RefPicListTemp0[ list_entry_l0[ rIdx ] ] : RefPicListTemp0[ rIdx ]
if(offsetPicLayerId && collocated_{—}from_{—}l0_{—}flag)

RefPicList0[ rIdx − 1] = ref_{—}pic_{—}list_{—}modification_{—}flag_{—}l0 ?

RefPicListTemp0[ list_{—}entry_{—}l0[ collocated_{—}ref_{—}idx ] +
NumRpsCurrTempList0 ] :
RefPicListTemp0[ collocated_{—}ref_{—}idx + NumRpsCurrTempList0]

When the slice is a B slice, the variable NumRpsCurrTempList1 is set equal to Max(num_ref_idx_{—}11_active_minus1+1, NumPicTotalCurr) and the list RefPicListTemp1 is constructed as follows:

rIdx = 0
while( rIdx < NumRpsCurrTempList1 ) {

for( i = 0; i < NumPocStCurrAfter && rIdx < NumRpsCurrTempList1; rIdx++, i++ )

RefPicListTemp1[ rIdx ] = RefPicSetStCurrAfter[ i ]

for( i = 0; i< NumActiveRefLayerPics1; rIdx++, i++ )

RefPicListTemp1[ rIdx ] = RefPicSetInterLayer1 [ i ]

for(i = 0; i < NumPocStCurrBefore && rIdx < NumRpsCurrTempList1; rIdx++, i++

)

RefPicListTemp1[ rIdx ] = RefPicSetStCurrBefore[ i ]

for( i = 0; i < NumPocLtCurr && rIdx < NumRpsCurrTempList1; rIdx++, i++ )

RefPicListTemp1[ rIdx ] = RefPicSetLtCurr[ i ]

for( i = 0; i< NumActiveRefLayerPics0; rIdx++, i++ )

RefPicListTemp1[ rIdx ] = RefPicSetInterLayer0[ i ]

}
while( rIdx < NumRpsCurrTempList1 << offsetPicLayerId ) {

for( i = 0; i < NumPocStCurrAfter && rIdx < NumRpsCurrTempList1; rIdx++, i++ )

RefPicListTemp1[ rIdx ] = RefPicSetStCurrAfter[ i + NumRpsCurrTempList1]

for( i = 0; i< NumActiveRefLayerPics1; rIdx++, i++ )

RefPicListTemp1[ rIdx ] = RefPicSetInterLayer1 [ i + NumRpsCurrTempList1]

for( i = 0; i < NumPocStCurrBefore && rIdx < NumRpsCurrTempList1; rIdx++,

i++ )

RefPicListTemp1[ rIdx ] = RefPicSetStCurrBefore[ i + NumRpsCurrTempList1]

for( i = 0; i < NumPocLtCurr && rIdx < NumRpsCurrTempList1; rIdx++, i++ )

RefPicListTemp1[ rIdx ] = RefPicSetLtCurr[ i + NumRpsCurrTempList1]

for( i = 0; i< NumActiveRefLayerPics0; rIdx++, i++ )

RefPicListTemp1[ rIdx ] = RefPicSetInterLayer0[ i + NumRpsCurrTempList1]

}

When the slice is a B slice, the list RefPicList1 is constructed as follows:

for( rIdx = 0; rIdx <= num_ref_idx_l1_active_minus1; rIdx++)

RefPicList1[ rIdx ] = ref_pic_list_modification_flag_l1 ?

RefPicListTemp1[ list_entry_l1[ rIdx ] ] : RefPicListTemp1[
rIdx ]
if(offsetPicLayerId && !collocated_{—}from_{—}l0_{—}flag)

RefPicList1[ rIdx − 1] = ref_{—}pic_{—}list_{—}modification_{—}flag_{—}l1 ?

RefPicListTemp1[ list_{—}entry_{—}l1[ collocated_{—}ref_{—}idx ] +
NumRpsCurrTempList1 ] :
RefPicListTemp1[ collocated_{—}ref_{—}idx + NumRpsCurrTempList1]

NOTE—Because motion vectors from inter layer reference pictures are constrained to be zero motion only, an SHVC encoder should disable temporal motion vector prediction for the current picture, by setting slice_temporal_mvp_enabled_flag to zero, when only inter-layer reference pictures exist in the reference picture lists of all slices in the current picture. This avoids the need to send any additional syntax elements such as collocated_from_{—}10_flag and collocated_ref_idx.
NOTE—When offsetPicLayerId is not equal to 0, the collocated_ref_idx shall be equal to the last index position in its respective list.

### Embodiment #2

### Copying Motion Information from Base Layer to Enhancement Layer

In one embodiment, the motion information of the BL can be copied to its collocated enhancement layer picture. For example, the RPL of the current picture may include one or more EL pictures. The motion information of the one or more EL pictures may be replaced with the motion information of one or more BL pictures. In one example, the motion information of an EL picture is overwritten with the motion information of a BL picture that is collocated with respect to the EL picture.

In one embodiment, the motion information copying process may be implemented at the 4×4 sub-block level. In another embodiment, the motion information copying process may be implemented at a sub-block level other than 4×4. The motion information copying process may be performed after decoding the enhancement layer picture whose motion information is being replaced/overwritten.

### Embodiment #3

### Copying Texture Information from Enhancement Layer to Base Layer

In one embodiment, the texture information of the EL can be copied to its collocated BL picture. For example, the RPL of the current picture may include one or more BL pictures. The texture information of the one or more BL pictures may be replaced with the texture information of one or more EL pictures. In one example, the texture information of a BL picture is overwritten with the texture information of an EL picture that is collocated with respect to the BL picture.

In one embodiment, the texture information copying process may be implemented at the 4×4 sub-block level. In another embodiment, the texture information copying process may be implemented at a sub-block level other than 4×4. The texture information copying process may be performed after decoding the enhancement layer picture whose texture information is being copied. In one embodiment, the EL picture may be resampled before its texture information is copied over to its collocated BL picture. The resampling may be based on the scalability ratio between the BL and the EL.

### Other Considerations

Information and signals disclosed herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The techniques described herein may be implemented in hardware, software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC). Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of inter-operative hardware units, including one or more processors as described above, in conjunction with suitable software and/or firmware.

Various embodiments of the invention have been described. These and other embodiments are within the scope of the following claims.

What is claimed is:

1. An apparatus configured to code video information, the apparatus comprising:
a memory unit configured to store video information associated with a current layer and an enhancement layer, the current layer having a current picture; and
a processor in communication with the memory unit, the processor configured to:
determine whether the current layer may be coded using information from the enhancement layer;
determine whether the enhancement layer has an enhancement layer picture corresponding to the current picture; and
in response to determining that the current layer may be coded using information from the enhancement layer and that the enhancement layer has an enhancement layer picture corresponding to the current picture, code the current picture based on the enhancement layer picture.

2. The apparatus of claim 1, wherein the processor is further configured to determine whether the current picture has a temporal ID greater than 0, wherein coding the current picture comprises coding the current picture based on the enhancement layer picture in response to determining that the current layer may be coded using information from the enhancement layer, that the enhancement layer has an enhancement layer picture corresponding to the current picture, and that the current picture has a temporal ID greater than 0.

3. The apparatus of claim 1, wherein the processor is further configured to determine whether the video information exhibits signal-to-noise ratio (SNR) or spatial scalability, wherein coding the current picture comprises coding the current picture based on the enhancement layer picture in response to determining that the current layer may be coded using information from the enhancement layer, that the enhancement layer has an enhancement layer picture corresponding to the current picture, and that the video information exhibits signal-to-noise ratio (SNR) or spatial scalability.

4. The apparatus of claim 1, wherein the enhancement layer comprises one or more higher layers having a layer ID that is greater than that of the current layer, and the enhancement layer picture comprises a picture from each of said one or more higher layers.

5. The apparatus of claim 1, wherein the determination of whether the current layer may be coded using information from the enhancement layer is the same for each picture having a temporal ID greater than 0 in the current layer within the same coded video sequence (CVS).

6. The apparatus of claim 1, wherein the determination of whether the current layer may be coded using information from the enhancement layer is the same for each picture having a temporal ID equal to 0 in the current layer within the same coded video sequence (CVS).

7. The apparatus of claim 1, wherein the processor is further configured to, in response to coding the current picture based on the enhancement layer picture, replace motion information associated with the coded enhancement layer picture with motion information of the coded current picture.

8. The apparatus of claim 1, wherein the processor is further configured to, after coding each picture in an access unit containing the current picture, replace motion information associated with a picture in the access unit in each layer having a layer ID greater than 0 with motion information of another picture in a layer that is immediately below said each layer.

9. The apparatus of claim 1, wherein the processor is further configured to:
disable a de-blocking filter and sample adoptive offset (SAO) for pictures in the current layer;
enable constrained intra prediction for pictures in the current layer;
disable motion prediction using non-zero motion information in the current layer;
disable bi-prediction in the enhancement layer when only one reference picture index associated with an enhancement layer block in the enhancement layer corresponds to the current picture and a co-located current layer block in the current picture uses bi-prediction; and
in response to said disabling of the de-blocking filter and SAO, said enabling of constraint intra prediction, said disabling of motion prediction, and said disabling bi-prediction, perform a single-loop coding of the video information.

10. The apparatus of claim 1, wherein the processor is configured to code the current picture based on the enhancement layer picture at least by coding the current picture using texture information associated with the enhancement layer picture and motion information associated with one or more pictures in the current layer.

11. The apparatus of claim 10, wherein the processor is further configured to:
replace motion information of another enhancement layer picture in the enhancement layer with motion information of another current layer picture corresponding to said another enhancement layer picture after said another enhancement layer picture is coded; and
code the current picture using the motion information of said another enhancement layer picture.

12. The apparatus of claim 10, wherein the processor is further configured to:
replace texture information of another current layer picture in the current layer with texture information of another enhancement layer picture corresponding to said another current layer picture after said another enhancement layer picture is coded; and
code the current picture using the texture information of said another current layer picture.

13. The apparatus of claim 1, wherein the apparatus comprises an encoder, and wherein the processor is further configured to encode the video information in a bitstream.

14. The apparatus of claim 1, wherein the apparatus comprises a decoder, and wherein the processor is further configured to decode the video information in a bitstream.

15. The apparatus of claim 1, wherein the apparatus comprises a device selected from a group consisting one or more of computers, notebooks, laptops, computers, tablet computers, set-top boxes, telephone handsets, smart phones, smart pads, televisions, cameras, display devices, digital media players, video gaming consoles, and in-car computers.

16. A method of coding video information, the method comprising:
determining whether a current layer may be coded using information from an enhancement layer;
determining whether the enhancement layer has an enhancement layer picture corresponding to a current picture in the current layer; and
in response to determining that the current layer may be coded using information from the enhancement layer and that the enhancement layer has an enhancement layer picture corresponding to the current picture, coding the current picture based on the enhancement layer picture.

17. The method of claim 16, further comprising determining whether the current picture has a temporal ID greater than 0, wherein coding the current picture comprises coding the current picture based on the enhancement layer picture in response to determining that the current layer may be coded using information from the enhancement layer, that the enhancement layer has an enhancement layer picture corresponding to the current picture, and that the current picture has a temporal ID greater than 0.

18. The method of claim 16, further comprising determining whether the video information exhibits signal-to-noise ratio (SNR) or spatial scalability, wherein coding the current picture comprises coding the current picture based on the enhancement layer picture in response to determining that the current layer may be coded using information from the enhancement layer, that the enhancement layer has an enhancement layer picture corresponding to the current picture, and that the video information exhibits signal-to-noise ratio (SNR) or spatial scalability.

19. The method of claim 16, further comprising transmitting or receiving a flag or syntax element that indicates whether an additional representation of the enhancement layer picture is needed before coding the current picture based on the enhancement layer picture.

20. The method of claim 16, wherein the enhancement layer comprises one or more higher layers having a layer ID that is greater than that of the current layer, and the enhancement layer picture comprises a picture from each of said one or more higher layers.

21. The method of claim 16, further comprising, in response to coding the current picture based on the enhancement layer picture, replacing motion information associated with the coded enhancement layer picture with motion information of the coded current picture.

22. The method of claim 16, further comprising, after coding each picture in an access unit containing the current picture, replacing motion information associated with a picture in the access unit in each layer having a layer ID greater than 0 with motion information of another picture in a layer that is immediately below said each layer.

23. The method of claim 16, further comprising:
disabling a de-blocking filter and sample adoptive offset (SAO) for pictures in the current layer;
enabling constrained intra prediction for pictures in the current layer;
disabling motion prediction using non-zero motion information in the current layer;
disabling bi-prediction in the enhancement layer when only one reference picture index associated with an enhancement layer block in the enhancement layer corresponds to the current picture and a co-located current layer block in the current picture uses bi-prediction; and
in response to said disabling of the de-blocking filter and SAO, said enabling of constraint intra prediction, said disabling of motion prediction, and said disabling bi-prediction, performing a single-loop coding of the video information.

24. The method of claim 16, wherein coding the current picture based on the enhancement layer picture comprises coding the current picture using texture information associated with the enhancement layer picture and motion information associated with one or more pictures in the current layer.

25. The method of claim 24, further comprising
replacing motion information of another enhancement layer picture in the enhancement layer with motion information of another current layer picture corresponding to said another enhancement layer picture after said another enhancement layer picture is coded; and
coding the current picture using the motion information of said another enhancement layer picture.

26. The method of claim 24, further comprising replacing texture information of another current layer picture in the current layer with texture information of another enhancement layer picture corresponding to said another current layer picture after said another enhancement layer picture is coded; and
coding the current picture using the texture information of said another current layer picture.

27. A non-transitory computer readable medium comprising code that, when executed, causes an apparatus to perform a process comprising:
storing video information associated with a current layer and an enhancement layer, the current layer having a current picture;
determining whether the current layer may be coded using information from the enhancement layer;
determining whether the enhancement layer has an enhancement layer picture corresponding to the current picture; and
in response to determining that the current layer may be coded using information from the enhancement layer and that the enhancement layer has an enhancement layer picture corresponding to the current picture, coding the current picture based on the enhancement layer picture.

28. The computer readable medium of claim 27, wherein the process further comprises determining whether the current picture has a temporal ID greater than 0, wherein coding the current picture comprises coding the current picture based on the enhancement layer picture in response to determining that the current layer may be coded using information from the enhancement layer, that the enhancement layer has an enhancement layer picture corresponding to the current picture, and that the current picture has a temporal ID greater than 0.

29. A video coding device configured to code video information, the video coding device comprising:
means for storing video information associated with a current layer and an enhancement layer, the current layer having a current picture;
means for determining whether the current layer may be coded using information from the enhancement layer;
means for determining whether the enhancement layer has an enhancement layer picture corresponding to the current picture; and
means for coding the current picture based on the enhancement layer picture in response to determining that the current layer may be coded using information from the enhancement layer and that the enhancement layer has an enhancement layer picture corresponding to the current picture.

30. The video coding device of claim 29, further comprising means for determining whether the current picture has a temporal ID greater than 0, wherein coding the current picture comprises coding the current picture based on the enhancement layer picture in response to determining that the current layer may be coded using information from the enhancement layer, that the enhancement layer has an enhancement layer picture corresponding to the current picture, and that the current picture has a temporal ID greater than 0.
